(19) United States
(12) Patent Application Publication
(10) Pub. No.: US 2026/0236316 A1
(43) Pub. Date: Aug. 13, 2026

(54) ORCHESTRATING A MULTI-TENANT SEARCH AND ANALYTICS ENGINE AND DATASTORE

(71) Applicant: ELASTIC TECHNOLOGIES (US) INC., WILMINGTON, DE (US)

(72) Inventors: TIMOTHY PHILIP VERNUM, SYDNEY (AU); HENNING ANDERSEN, SILKEBORG (DK); JASON TEDOR, AVON, OH (US); ADRIEN GRAND, MAISONCELLES-PELVEY (FR); RORY DAVID NESS MACKENZIE, FENWICK (GB)

(21) Appl. No.: 19/539,543

(22) Filed: Feb. 13, 2026

Related U.S. Application Data
(60) Provisional application No. 63/758,147, filed on Feb. 13, 2025.

(51) Int. Cl. G06F 9/50

(52) U.S. Cl. CPC G06F 9/5072

(57) ABSTRACT

In a particular embodiment, a method of orchestrating projects in a distributed search and analytics platform is disclosed that includes managing, by a project controller executing on one or more processors, assignment of a plurality of projects to a plurality of distributed search and analytics clusters. In this embodiment, each project is assigned to exactly one cluster at a time and at least one cluster hosting multiple projects of the plurality of projects. The method also includes the project controller managing namespaces for the plurality of projects within the plurality of distributed search and analytics clusters. In addition, the method also includes configuring, by the project controller, request routing for the plurality of projects to direct requests associated with a project to the cluster hosting the project. In this embodiment, the method also includes associating, by the project controller, each project with separate storage allocated for the project.

### BACKGROUND

Distributed search and analytics systems are commonly deployed to enable fast indexing, querying, and analysis of large volumes of data. Such systems are often implemented as clusters of computing nodes that collectively execute a distributed search engine capable of supporting high query throughput and low-latency responses. These systems are widely used to support a variety of workloads, including search, logging, observability, security analytics, and other data-intensive applications.

As usage of distributed search and analytics platforms increases, it is common for a single organization or service provider to operate multiple independent projects or workloads. Each project may correspond to a distinct application, customer, tenant, or use case, and may have different data sets, performance requirements, and access controls. Traditionally, isolation between projects has been achieved by deploying separate clusters for each project or by requiring manual configuration of naming conventions within a shared cluster. Deploying separate clusters can lead to inefficient resource utilization, increased operational complexity, and higher infrastructure costs, particularly when project workloads are bursty or uneven over time.

Operating multiple projects within a shared cluster presents technical challenges related to isolation, resource management, and request processing. Projects may compete for compute, memory, storage, and input/output resources, leading to unpredictable performance and resource contention. Additionally, requests associated with one project must be prevented from accessing data or resources associated with other projects. Conventional approaches that rely on static configuration or client-defined naming schemes can increase operational burden and limit flexibility, particularly when projects are dynamically created, removed, or migrated.

Further, workloads hosted by a distributed search and analytics platform may vary significantly in resource intensity over time. A project experiencing high query volume, intensive indexing, or complex analytics may adversely impact the performance of other projects sharing the same cluster. Static provisioning or fixed allocation of resources may be insufficient to address such dynamic behavior, while manual intervention to isolate or scale resources can be slow and error-prone.

Accordingly, there is a need for improved techniques that enable a distributed search and analytics platform to host multiple independent projects within shared infrastructure while maintaining isolation, predictable performance, and efficient resource utilization.

### SUMMARY

The following summary is meant to help one skilled in the art understand the various presently disclosed combinations of features. It is not meant to unduly limit the scope of any pending or future claims relating to the disclosure.

Methods, systems, and computer program products are disclosed for orchestrating projects in a distributed search and analytics platform. In various embodiments, a project controller manages assignment of a plurality of projects to a plurality of distributed search and analytics clusters such that each project is assigned to exactly one cluster at a time while at least one cluster hosts multiple projects. The project controller manages namespaces for the projects within the clusters, configures request routing to direct requests associated with a project to the cluster hosting the project, and associates each project with separate storage allocated for the project. Requests directed to a distributed search engine are serviced by nodes of a cluster by associating each request with a project identifier, determining project ownership information, identifying a namespace corresponding to the project, and executing search engine operations scoped to the namespace to prevent access to resources of other projects. In further embodiments, the project controller monitors resource utilization associated with projects, detects resource-intensive projects, and dynamically isolates such projects by routing their requests to designated sets of nodes that may be scaled independently of other nodes in the cluster, thereby enabling efficient resource utilization while maintaining isolation and predictable performance across multiple projects hosted by shared infrastructure.

In a particular embodiment, a method of orchestrating projects in a distributed search and analytics platform is disclosed that includes managing, by a project controller executing on one or more processors, assignment of a plurality of projects to a plurality of distributed search and analytics clusters. In this embodiment, each project is assigned to exactly one cluster at a time and at least one cluster hosting multiple projects of the plurality of projects. The method also includes the project controller managing namespaces for the plurality of projects within the plurality of distributed search and analytics clusters. In addition, the method also includes configuring, by the project controller, request routing for the plurality of projects to direct requests associated with a project to the cluster hosting the project. In this embodiment, the method also includes associating, by the project controller, each project with separate storage allocated for the project.

In another embodiment, a method of servicing requests in a distributed search and analytics platform hosting a plurality of projects is disclosed that includes receiving, by a node of a distributed search and analytics cluster, a request directed to a distributed search engine and receiving, by the node, a project identifier associated with the request. The method also includes determining based on the project identifier, by the node, project ownership information identifying a project assigned to the cluster and identifying, by the node, a namespace corresponding exclusively to the project. In addition, the method also includes servicing, by the node, the request by executing search engine operations scoped to the namespace without accessing resources associated with other projects hosted by the cluster.

In another embodiment, a method of handling a resource-intensive project in a distributed search and analytics platform that includes monitoring, by a project controller executing on one or more processors, resource utilization associated with each of a plurality of projects hosted by a distributed search and analytics cluster. In addition, the method also includes the project controller detects that a project exceeds a resource utilization threshold and in response to detecting that the project exceeds the resource utilization threshold, isolating the project by configuring the cluster to route requests associated with the project to a designated set of nodes of the cluster. The method also includes configuring, by the project controller, the cluster such that requests associated with other projects are routed to nodes outside the designated set of nodes.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

One or more aspects of the present disclosure are discussed below with reference to the accompanying Figures. It will be appreciated that for simplicity and clarity of illustration, elements shown in the drawings have not necessarily been drawn accurately or to scale. For example, the dimensions of some of the elements may be exaggerated relative to other elements for clarity or several physical components may be included in one functional block or element.

Further, where considered appropriate, reference numerals may be repeated among the drawings to indicate corresponding or analogous elements. For purposes of clarity, however, not every component may be labeled in every drawing. The Figures are provided for the purposes of illustration and explanation and are not intended to be limiting. In the Figures:

FIG. 1 sets forth a block diagram illustrating a particular implementation of a system for orchestrating a multi-tenant search and analytics engine and datastore.

FIG. 2 is a flowchart to illustrate an implementation of a method of orchestrating a multi-tenant search and analytics engine and datastore in accordance with at least one embodiment of the present disclosure.

FIG. 3 is a flowchart to illustrate another implementation of a method of orchestrating a multi-tenant search and analytics engine and datastore in accordance with at least one embodiment of the present disclosure.

FIG. 4 is a flowchart to illustrate another implementation of a method of orchestrating a multi-tenant search and analytics engine and datastore in accordance with at least one embodiment of the present disclosure.

FIG. 5 is a block diagram of an example computing environment of orchestrating a multi-tenant search and analytics engine and datastore in accordance with at least one embodiment of the present disclosure.

FIG. 6 is a flowchart illustrating a method of orchestrating projects in a distributed search and analytics platform in accordance with at least one embodiment of the present disclosure.

FIG. 7 is a flowchart illustrating another method of orchestrating projects in a distributed search and analytics platform in accordance with at least one embodiment of the present disclosure.

FIG. 8 is a flowchart illustrating another method of orchestrating projects in a distributed search and analytics platform in accordance with at least one embodiment of the present disclosure.

FIG. 9 is a flowchart illustrating another method of orchestrating projects in a distributed search and analytics platform in accordance with at least one embodiment of the present disclosure.

FIG. 10 is a flowchart illustrating another method of orchestrating projects in a distributed search and analytics platform in accordance with at least one embodiment of the present disclosure.

FIG. 11 is a flowchart illustrating another method of orchestrating projects in a distributed search and analytics platform in accordance with at least one embodiment of the present disclosure.

FIG. 12 is a flowchart illustrating another method of orchestrating projects in a distributed search and analytics platform in accordance with at least one embodiment of the present disclosure.

FIG. 13 is a flowchart illustrating another method of orchestrating projects in a distributed search and analytics platform in accordance with at least one embodiment of the present disclosure.

FIG. 14 is a flowchart illustrating another method of orchestrating projects in a distributed search and analytics platform in accordance with at least one embodiment of the present disclosure.

FIG. 15 is a flowchart illustrating another method of orchestrating projects in a distributed search and analytics platform in accordance with at least one embodiment of the present disclosure.

FIG. 16 is a flowchart illustrating a method of servicing requests in a distributed search and analytics platform in accordance with at least one embodiment of the present disclosure.

FIG. 17 is a flowchart illustrating another method of servicing requests in a distributed search and analytics platform in accordance with at least one embodiment of the present disclosure.

FIG. 18 is a flowchart illustrating a method of handling a resource-intensive project in a distributed search and analytics platform in accordance with at least one embodiment of the present disclosure.

FIG. 19 is a flowchart illustrating another method of handling a resource-intensive project in a distributed search and analytics platform in accordance with at least one embodiment of the present disclosure.

FIG. 20 is a flowchart illustrating another method of handling a resource-intensive project in a distributed search and analytics platform in accordance with at least one embodiment of the present disclosure.

### DETAILED DESCRIPTION

The following detailed description describes various embodiments and combinations of features in order to provide a person of ordinary skill in the art with an understanding of the principles and implementations of the present disclosure. It will be understood that the disclosed embodiments may be practiced without some of the specific details set forth herein. In some instances, well-known methods, procedures, components, and structures are not described in detail so as not to unnecessarily obscure aspects of the present disclosure. The following detailed description is not intended to limit the scope of the present disclosure or of any claims in this or any related application. In addition, the same or similar features may be described using different terminology or reference numerals, and reference numerals may be repeated among the drawings to indicate corresponding or analogous elements. For clarity, not every component is necessarily labeled in every drawing.

The terminology used herein is for the purpose of describing particular embodiments only and is not intended to be limiting. As used herein, the singular forms “a,” “an,” and “the” are intended to include the plural forms as well, unless the context clearly indicates otherwise. Likewise, a feature described as being implemented using a single element may, in other embodiments, be implemented using multiple elements, and a feature described as being implemented using multiple elements may, in other embodiments, be implemented using a single element or processing entity. The terms “comprises,” “comprising,” “includes,” and “including” specify the presence of stated features, steps, operations, elements, or components, but do not preclude the presence or addition of one or more other features, steps, operations, elements, components, or groups thereof.

As used herein, when an element is described as being “connected” or “coupled” to another element, the elements may be directly connected or coupled, or connected or coupled through one or more intervening elements. When a combination of elements is described using the term “or,” the description is intended to encompass any and all combinations of the listed elements, including individual elements and combinations thereof. The phrase “at least one of” is used interchangeably with such combinations and is intended to have the same inclusive meaning.

Accordingly, although certain embodiments are illustrated in the drawings and described herein in detail, the present disclosure is not limited to the specific embodiments disclosed. Rather, the disclosure encompasses all modifications, equivalents, and alternatives that fall within the scope of the disclosure as defined by the claims.

Building a scalable search engine and datastore is complex because such applications are typically resource intensive. User interactions tend to be bursty (e.g., searches during peak events like e-commerce sales or when investigating an incident) while also requiring low latencies. Consequently, such applications often require over-provisioning for peak loads and autoscaling mechanisms. These applications are typically isolated to specific hardware to avoid resource contention (also referred to as a ‘noisy neighbor’ problem). Historically, the colocation of multiple projects has sacrificed the independence of each project. For example, this has been achieved by requiring the use of a naming scheme so that the use cases can coexist within a single shared namespace. Embodiments in accordance with the present disclosure allow such use cases to be co-located at large scale (e.g., hundreds of use cases) within one search engine cluster.

Embodiments disclosed herein provide a mechanism to orchestrate and serve many independent projects within a single search engine cluster (referred to herein as a ‘multi-project search engine cluster’), rather than requiring a search engine cluster per project as is traditionally required. This mechanism significantly reduces the resources required to run multiple projects, such as hardware costs (e.g., less CPU and RAM requirements) and cloud costs (e.g., reducing calls to cloud-based object storage). Each project retains its independence while benefiting from an improved user experience due to incoming queries being able to leverage the additional capacity of the multi-project search engine cluster immediately, rather than requiring autoscaling of the cluster as traditionally would happen.

Embodiments disclosed herein service multiple projects within a single operating system process (on each hardware node), thus reducing per-project infrastructure costs by sharing the underlying hardware across multiple projects. Further, the embodiments provide more predictable performance characteristics by sharing unused system capacity, while offering each project the full set of features and APIs normally provided by the search engine without the users of each project being aware of the collocated projects on the cluster. Selected data storage for each project can be isolated for data independence and security. Problematic ‘noisy neighbor’ projects can be isolated to their own set of nodes within the multi-project search engine cluster, which can auto-scale independently of the rest of the cluster.

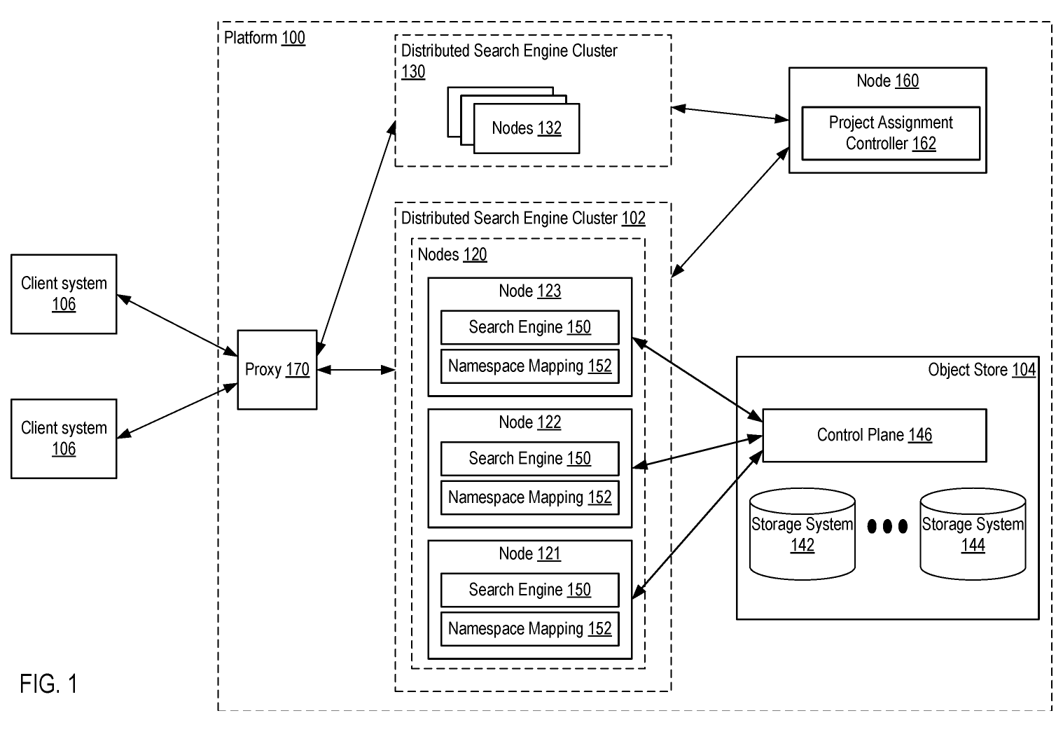

Exemplary methods, apparatuses, and computer program products for orchestrating a multi-tenant search and analytics engine and datastore in accordance with the present invention are described with reference to the accompanying drawings, beginning with FIG. 1. FIG. 1 sets forth a block diagram of an example search and analytics platform 100 for orchestrating a multi-tenant search and analytics engine and datastore in accordance with at least one embodiment of the present disclosure. The example platform 100 includes a distributed search engine cluster 102 that receives data from client systems 106, indexes and stores the data, and responds to search queries from client systems 106 with the data relevant to the query using the index. Cluster 102 includes two or more nodes 120 – in the example of FIG. 1, the two or more nodes 120 includes nodes 121, 122, 123. The nodes 120 execute a distributed search engine application 150, which is described in more detail below. For the purpose of illustration, platform 100 also includes a second cluster 130 that includes two or more nodes 132. It will be appreciated that implementations consistent with the present disclosure are not limited to a particular number of clusters or nodes. The example platform 100 also includes object store 104 that provides object- based storage for data. Interaction between cluster 102 and the object store 104 will be described in more detail below.

As mentioned above, a traditional system isolates projects to specific hardware to avoid resource contention or otherwise requires the user to configure different namespaces for each project. In accordance with embodiments of the present disclosure, a distributed search and analytics platform 100 provides automated project assignment and management that does not require client awareness of project namespaces. A project is assigned to a cluster, and each project has its own namespace within a cluster, ensuring metadata and name isolation between projects. Further, the distributed search and analytics platform may provide storage isolation for projects and optional compute hardware isolation for projects.

As used herein, a “project” refers to a logically independent workload, tenant, or use case hosted by the distributed search and analytics platform. A project may be associated with a distinct set of data, named resources (e.g., indices, templates, ingestion pipelines, and security roles), and access controls, and may be serviced by a distributed search and analytics cluster while remaining isolated from other projects. In various embodiments, a project is assigned to exactly one cluster at a time and is associated with a project identifier used to scope request processing and resource access for that project.

As shown in FIG. 1, the distributed search engine application 150 executes on a cluster (e.g., cluster 102) that is a logical grouping of nodes (e.g., nodes 120) working together to perform indexing and query operations. Each node executes an instance of the search engine application 150. In some examples, nodes 120 within cluster 102 may be specialized into different roles or combinations of roles. Master nodes may manage the cluster state and coordinate operations, data nodes may index and store data, search nodes may execute queries, client nodes may act as intermediaries between external users and the cluster, and ingest nodes may preprocess incoming data through pipelines for transformation and enrichment before indexing.

In some examples, platform 100 uses a distributed indexing mechanism, organizing data into logical units called indices. Each index is divided into shards, which are self-contained search units capable of handling indexing and query operations. Shards are further classified into primary shards, which hold the original indexed data, and replica shards, which maintain redundant copies for fault tolerance or additional search throughput. These shards are dynamically distributed across nodes to balance workload and optimize performance. These indices and shards are named resources that may be associated with a particular project out of multiple projects serviced by the cluster 102.

A query may be associated with a particular project. Query execution follows a distributed execution model. A query is parsed into actionable components and routed to relevant shards based on metadata and routing algorithms, including namespace mappings. The subcomponents are processed in parallel across multiple shards, and the results are aggregated and ranked to provide a consolidated response to the user. Thus, each node 120 in cluster 102 is configured to provide equivalent access to distributed search engine services, including indexing and search operations, across all nodes 120 in the cluster 102, and for each project deployed on the cluster.

High fidelity durability is achieved by persisting data in cloud storage. Fault tolerance is achieved by having active search replicas that can serve searches and indexing replicas that are ready to take over indexing in case of a node failure. In the event of a node failure, replica shards are promoted to primary shards, allowing uninterrupted operations. Platform 100 supports dynamic scaling by allowing nodes to be added or removed from the cluster, with automatic redistribution of shards to utilize new resources effectively. For disaster recovery, periodic snapshots of indices can be taken, enabling restoration of data.

Platform 100 may be characterized by centralized cluster state management, with an active master node synchronizing metadata across all nodes. This includes managing node availability, shard allocation, and index creation, as well as taking on the ownership of a project, its data and its metadata. Master node elections may use consensus-based protocols to ensure continuous management in case of failures. Regular health checks may monitor shard availability, with automatic reallocation of unresponsive shards.

Platform 100 may be characterized by performance optimizations such as hashed routing to minimize query overhead by directing queries to specific shards efficiently and query caching to reduce latency for frequently executed queries. Load balancing may be achieved through dynamic shard allocation based on node capacity and workload, preventing bottlenecks. Horizontal scalability allows seamless integration of additional nodes into the architecture.

In some examples, two or more nodes 120 in cluster 102 are configured for indexing data. These nodes are operable to ingest data received from a client system 106 and generate an index data for the ingested data. The index data is then stored in the data structure for the index. Generating an index can include parsing and tokenizing the data and generating fields with values to be stored in the index. In some examples, each index is identified by a unique name within a project namespace and is divided into one or more shards, which are smaller subsets of the index that allow for parallel processing and distributed storage. In some examples, the generated index data may also include additional data structures to help with for example ranking, scoring and aggregations. These indices and shards are named resources of a project, which are isolated from other projects serviced by the cluster 102.

In some examples, one or more nodes 120 in cluster 102 are configured for handling search queries. These nodes 120 receive a query from a client system 106, parse and tokenize the query using natural language processing, and employ the index to locate the documents most relevant to the query. Based on the identified tokens, the node 120 accesses the index to identify relevant documents. The data node can also perform various ranking, aggregation, and analytics operations on the returned data. As such, search workloads can vary in the computational resources they demand. Queries and templates are associated with a particular project serviced by cluster 102.

In some examples, a subset of nodes in cluster 102 are dedicated to indexing data, while another subset of nodes in cluster 102 are dedicated to responding to queries. In these examples, nodes 120 are partitioned into indexing nodes and search nodes such that indexing and search capabilities are divorced from one another, thus allowing indexing nodes or search nodes to be instantiated on demand without the computational resources needed to execute both functionalities.

In some examples, each node 120 in cluster 102 is configured with dynamic namespacing mechanism for ensuring a project has its own namespace. This mechanism does not require client awareness of these namespaces. The search engine application 150 maintains a unique namespace for each project served by cluster 102. In this way, named resources for each project are stored in separate namespaces, allowing multiple projects to coexist on a node without naming collisions. These named resources can include, for example, indices, templates, security roles, ingestion pipelines, and so on. Each project’s namespace may be maintained in memory on each node 120 of cluster 102 and/or stored in persistent storage. In the example of FIG. 1, each node maintains a namespace map 152, which may be implemented as a data structure that maps project identifiers to a corresponding namespace.

In some examples, each API request received by the search engine application 150 is automatically applied to the correct namespace based on the project identifier that is inferred from the API request. For example, the project identifier may be supplied using an HTTP header set securely by a trusted component. In some implementations, a proxy server or namespace management server sets the HTTP header with the project identifier. In other implementations, the project identifier is provided via a mechanism other than the HTTP header, for example in the hostname or as a URL parameter. The search engine application 150 uses this identifier to determine the correct namespace for an API request, and all data accessed or modified by the request is scoped to that namespace. As mentioned above, selected data for each project is isolated within the backing store, allowing each project to maintain its data independence.

In some examples, a project assignment controller 162 implements an orchestration system to orchestrate which projects are allocated to which clusters based on users creating projects and otherwise automatically handling projects during their lifetime. The project assignment controller 162 creates projects in response to user requests and then assigns the project to a cluster that ensures that the project has its own namespace within that cluster as well as necessary information (location, authentication) for accessing the project’s separate storage. The project assignment controller 162 determines when to add a new cluster for the project vs. assign a project to a specific cluster. While there may be multiple clusters in the platform at any given time, a project is assigned to only one cluster at a time. In some examples, the project assignment controller 162 can move projects online and offline between clusters in order to isolate projects, balance load, or handle other system maintenance. In some examples, the namespace map 152 is updated on the node 120 in response to instructions from a node 160 that hosts project assignment controller 162. The project assignment controller 162 is configured to add, remove, or modify namespaces and send instructions to a node 120 being assigned with the project to update the namespace map 152 accordingly. That node 120 then updates metadata for cluster 102 based on the assignment. In some examples, project namespaces are created and removed by the project assignment controller 162 based on workload behavior such as user or workload demand. For example, the project assignment controller 162 may be configured to monitor workloads and requests received by cluster 102. The project assignment controller 162 manages the availability of clusters with spare capacity for new projects and schedules the project on an available cluster. This flexibility allows for efficient resource allocation and better handling of varying workloads. In some examples, the node 160 hosting the project assignment controller 162 is external to cluster 102.

In this way, a platform in accordance with the present disclosure provides automated namespace handling through which namespaces for each project are automatically created and managed through mechanisms that ensure isolation without requiring manual intervention or configuration by users. Namespaces are dynamically created and removed based on instructions from the external project assignment controller, allowing for flexible and efficient resource management. As the namespace map 152 and project identifiers provide that each project operates within its own namespace, naming collisions are prevented and data independence maintained. Further, this namespace isolation based on a secure project identifier facilitates security management and access controls.

In some examples, one or more nodes 120 are configured to manage node association, where the cluster is configured to dedicate one or more nodes in cluster 102 to a specific project or a set of projects. Any API requests targeting one of these projects will be routed to these specified nodes (e.g., specific hardware resources hosting the nodes), thus providing separate pools of memory, compute, and disk resources for distinct collections of projects. In some examples, a node 120 that is a master node may be configured to manage hardware node association for the cluster. For example, a resource-intensive project can be isolated to its own set of dedicated nodes in the cluster 102, thus preventing the project from impacting the performance of other projects within the cluster. In this way, a ‘noisy neighbor’ project is isolated to its own node or set of nodes within cluster 102. In some implementations, a set of nodes dedicated to a project can be configured to auto-scale independently of cluster 102, thus providing tailored resource allocation based on the needs of a project. Further, the dedicated node association can be configured dynamically on a cluster, thus allowing projects to be isolated for a period of time.

In an example implementation, a secure link is established between a client system 106 and a secure proxy 170 of platform 100. The secure proxy 170 receives one or more API requests directed to the distributed search engine application 150. The secure proxy 170 inserts a project identifier into the API request based on, for example, information included in the API request or information associated with the secure link (e.g., a credential). This project identifier can be dynamically created. In some examples, the project identifier is inserted in the API request by modifying an HTTP header of the request. For example, the project identifier may be inserted based on an established project-cluster association. If the project identifier is not already associated with a cluster, the project assignment controller 162 executing on node 160 dynamically allocates the project to a cluster by creating a namespace for the project in the cluster. In some examples, the project assignment controller 162 or another management entity assigns the project and namespace to a particular cluster, i.e., cluster 102 in the example of FIG. 1. In these examples, the project assignment controller 162 sends an instruction to nodes 120 in cluster 102 to update a namespace mapping 152 to include the new namespace for the new project. The API request with the project identifier is then forwarded to cluster 102. As future API requests are received that are part of the same project, the secure proxy 170 inserts the same project identifier into the API request and forwards the request to cluster 102.

When a node 120 in the cluster receives the API request, the search engine application executing on the node 120 identifies a namespace for the API request based on the project identifier and the namespace mapping 152. The node 120 then services the API request using the namespace by, for example, accessing named resources such as indices, shards, templates, etc., within the namespace. In this way, when multiple projects are deployed on a single cluster, naming collisions are avoided and data security is maintained, as the API request will not be able to access resources outside of the namespace. The data backing the resources of the namespace is stored in private persistent storage that is separate from data for all other projects deployed on cluster 102.

In some examples, one node 121 may determine, based on utilization metrics, that a particular project is oversubscribing the resources of the nodes 120 in cluster 102. For example, node 121 may be a master node. In these examples, the node 121 can configure cluster 102 to route all API requests for that project to a particular node or set of nodes, such as node 123. This isolates the project from other projects that continue to execute on nodes 121 and 122. Should project demand continue to grow, the nodes dedicated to the project can be horizontally scaled, independently of other nodes in cluster 102, to include new nodes dedicated to the project. For example, new nodes can be added to cluster 102, such that those nodes are dedicated to the project.

A node 120 can be implemented by a variety of constructs. In some examples, a node 120 is implemented as all or a portion of a distributed search engine application executing on a virtual machine. In these examples, the virtual machine is hosted on a bare metal server and can be spun up and torn down as needed to provide scalability as workload demands change, thus providing efficient utilization of computation resources. A hypervisor may provide automated deployment, scaling and management of virtual machines to support indexing workloads. In some examples, nodes 120 are implemented as containerized applications that include all or a portion of a distributed search engine, allowing nodes to be spun up and torn down as needed. Containerized applications can be managed through a container orchestration environment such as, for example, Kubernetes or Docker, for automated deployment, scaling and management of containerized applications. In some examples, the project assignment controller 162 is integrated with the container orchestration environment. In some examples, data nodes are implemented by all or a portion of a distributed search engine application executing on cloud computing resources. For example, public cloud computing resources that can execute a node 120 include Elastic Compute Cloud (EC2) compute instances provided by Amazon Web Services, Azure virtual machines provided by Microsoft Azure, and/or Google Compute Engines (GCE) provided Google Cloud Platform. Nodes 120 can be implemented by similar resources provided in private cloud systems.

In some examples, nodes 120 are each provisioned with local storage. Local storage can be any form of storage for computers that is now known or to be developed in the future. Some familiar forms of persistent storage include magnetic disks and solid-state storage devices. In some examples, local storage can be a portion of persistent storage in the server hosting the node, for example, persistent storage allocated to a virtual machine or container. In some examples, persistent storage can be cloud-based persistent storage for compute instances, such as Elastic Block Store (EBS) in AWS, Managed Disks in Azure, and Compute Engine persistent disks in GCP. As will be explained in more detail below, in accordance with embodiments of the present disclosure, local storage is used to temporarily store shards of the index during indexing.

In some examples, cluster 102 is deployed on one or more servers in one or more on-premises data centers. In other examples, cluster 102 is deployed on cloud computing resources of a public cloud service provider, such as Amazon Web Services, Microsoft Azure, or Google Cloud Platform. As previously discussed, the nodes 120 can be configured to execute on such resources. In further examples, cluster 102 is configured to operate on-premises and dynamically scale cloud resources as needed. For example, during periods of high demand for indexing, search, and analytics, one or more indexing or search instances can be spun up on a cloud computing instance to operate in parallel to on-premises instances.

The object store 104 provides object-based persistent storage for cluster 102. In some examples, the object store 104 is partitioned such that data for each project is stored separately in the object store 104 to maintain data independence and security. It will be appreciated that, in some examples, a separate object store 104 allocated for each project to maintain data independence and security. In some examples, object store 104 is implemented as a cloud-based object store. For example, object store 104 can be S3 object storage provided by AWS, Blob Storage provided by Azure, or Google Cloud Storage provided by GCP, among other publicly or privately available object-based storage platforms, as well as network file system storage or other file storage that provides durability and consistency. Such platforms provide storage provisioning and data replication across multiple physical storage systems 142, 144. For example, object data can be stored on one physical storage system underlying the cloud-based object store 104 and replicated to another physical storage system underlying the cloud-based object storage 104. In some examples, the object store 104 includes a control plane 146 that controls the servicing (reading and writing) of data in the object store 104 as well as the provisioning, replication, migration, and tiering of data in the object store 104. In such examples, the control plane can provide an application programming interface (API) to cluster 102. Through this API, cluster 102 can write and read data from the object store 104. In some examples, the physical storage systems 142, 144 underlying the object store 104 are distributed across different geographic regions, or “availability” zones, with separate availability and survivability in cases of wide-scale data center outages, network failures, power grid failures, and so on. Commercially available cloud platforms can provide reliability, availability, data redundancy, and recoverability guarantees for data generated and utilized by cluster 102. This relieves cluster 102 of providing and managing such features.

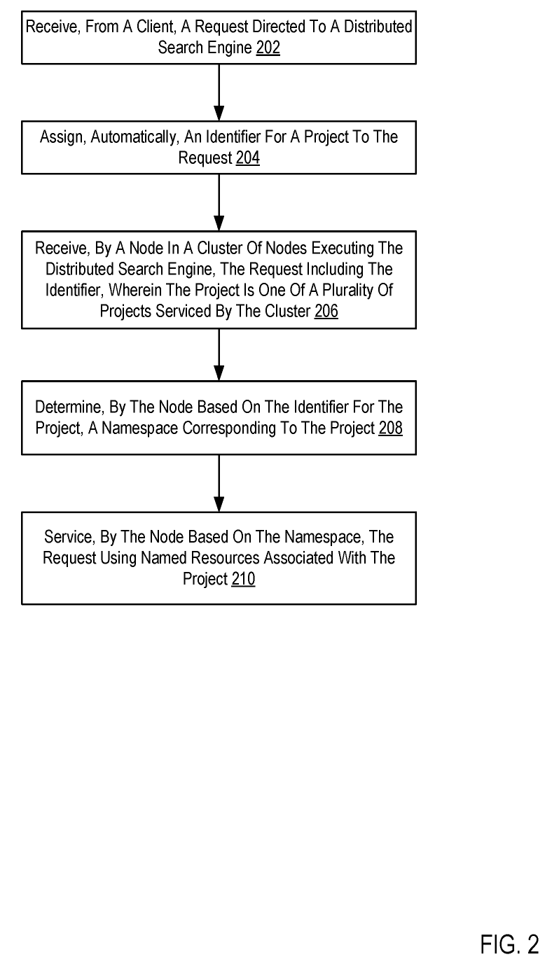

For further explanation, FIG. 2 sets forth a flow chart of an example method for orchestrating a multi-tenant search and analytics engine and datastore in accordance with at least one embodiment of the present disclosure. The example method of FIG. 2 includes receiving 202, from a client, a request directed to a distributed search engine. In some examples, a proxy server receives 202 the request directed to the distributed search engine by receiving an API request. An example implementation for receiving 202 the request at the proxy server is discussed above.

The method of FIG. 2 also includes assigning 204, automatically, an identifier for a project to the request. In some examples, the proxy server assigns 204 the identifier for the project to the request automatically based on information associated with the request. An example implementation for automatically assigning 204 the identifier is discussed above.

The method of FIG. 2 also includes receiving 206, by a node in a cluster of nodes executing the distributed search engine, the request including the identifier, wherein the project is one of a plurality of projects serviced by the cluster. In some examples, the node executing the distributed search engine application receives 206 the request from the proxy server. The request includes the identifier for the project that was securely added by the proxy service.

The method of FIG. 2 also includes determining 208, by the node based on the identifier for the project, a namespace corresponding to the project. In some examples, the node determines the 208 the namespace by accessing a namespace mapping data structure that maps a project identifier to a namespace for the project. For example, each node in the cluster maintains the same namespace mapping data structure that includes project identifier and namespaces for each project serviced by the cluster.

The method of FIG. 2 also includes servicing 210, by the node based on the namespace, the request using named resources associated with the project. In some examples, the node services 210 the request based on the namespace by identifying named resources in the request, such as indices, shards, etc., and accessing those named resources within the namespace. In some examples, data for each project is stored in separate storage for that project, where the separate storage corresponds to the namespace. In some implementations, the identifier is inserted into a header of the request. In some implementations, projects are dynamically added to and removed from the cluster based on demand. In some implementations, when a project is added to a cluster, a master node will ensure that the knowledge that this project is owned by this cluster (and the associated metadata and namespace) is communicated to the rest of the nodes.

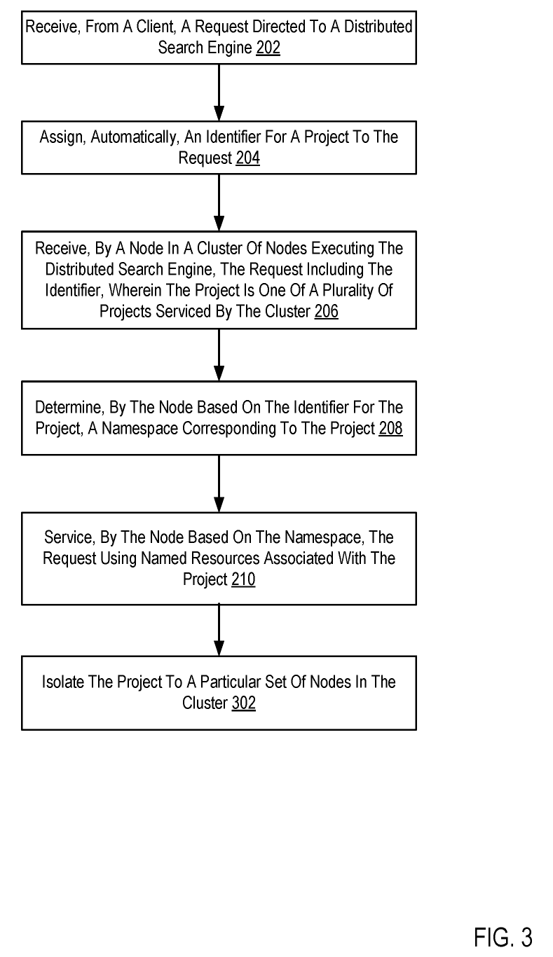

For further explanation, FIG. 3 sets forth a flow chart of another example method for orchestrating a multi-tenant search and analytics engine and datastore in accordance with the present disclosure. The method of FIG. 3 extends the method of FIG. 2 in that the method of FIG. 3 also includes isolating 302 the project to a particular set of nodes in the cluster. In some examples, a node (e.g., a master node for cluster state management), isolates 302 a project to a particular set of nodes by configuring the cluster to route all requests associated with the project to the particular set of nodes. For a resource-intensive project that may interfere with other projects, this provides separate pools of memory, compute, and disk resources for the project to avoid resource contention with the other projects.

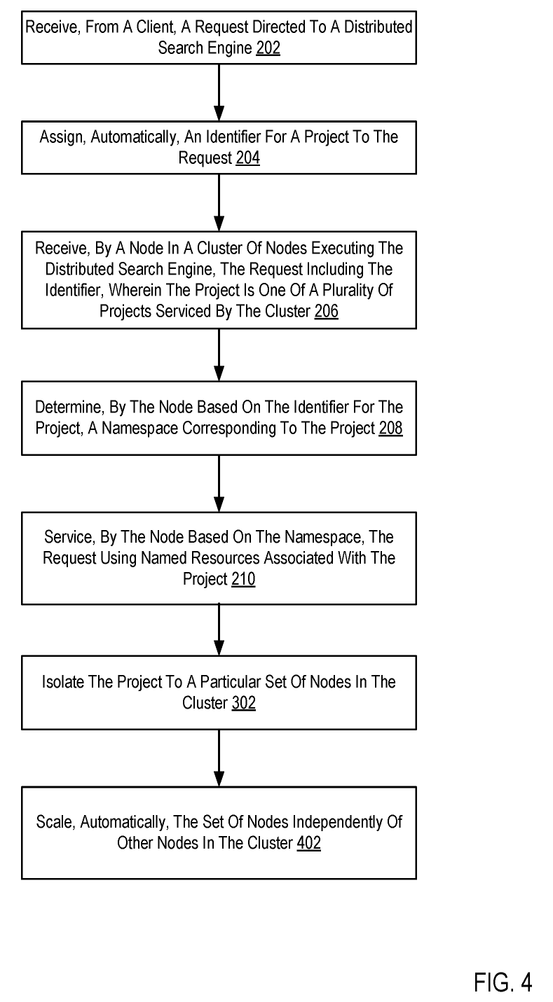

For further explanation, FIG. 4 sets forth a flow chart of another example method for orchestrating a multi-tenant search and analytics engine and datastore in accordance with the present disclosure. The method of FIG. 4 extends the method of FIG. 3 in that the method of FIG. 4 also includes scaling 402, automatically, the set of nodes independently of other nodes in the cluster. In some examples, the set of isolated nodes for a particular project are scaled horizontally and independently of the other nodes in the cluster, thus mitigating the impact of the project on other projects serviced by the cluster while also allowing the resources dedicated to the project to automatically scale.

In view of the foregoing, it will be appreciated that a search and analytics platform for orchestrating a multi-tenant search and analytics engine and datastore in accordance with the present disclosure improves the efficiency, scalability, performance, and user experience of a distributed search engine using namespace isolation with dynamic resource management, dedicated node allocation, independent autoscaling, and comprehensive feature availability. The search and analytics platform reduces hardware costs by sharing the underlying hardware across multiple projects and reducing the minimum hardware cost per project for relatively inactive projects, as well as raising the hardware utilization of more active projects. The need for separate hardware for each project is eliminated, leading to significant cost savings in terms of CPU, RAM, and storage. The platform may lower cloud services costs by consolidating multiple projects into a single cluster and reducing the number of calls to cloud storage services (e.g., S3), leading to lower operational costs. The shared infrastructure allows for more predictable performance characteristics by utilizing unused system capacity. This helps in managing bursty workloads more efficiently. Further, the platform enables immediate capacity utilization, where incoming queries can immediately take advantage of the additional capacity within the multi-project cluster, reducing the need for autoscaling and improving response times.

Enhanced isolation and management through namespace isolation ensures that each project operates within its own namespace, preventing naming collisions and ensuring data independence. This isolation also helps in managing security and access controls more effectively. Resource-intensive projects can be isolated to their own set of nodes, preventing them from impacting the performance of other projects within the cluster.

Dynamic project management is facilitated by an external controller that can dynamically create and remove projects based on demand. This flexibility allows for efficient resource allocation and better handling of varying workloads. Specific nodes can be dedicated to particular projects, allowing for independent autoscaling of those nodes without affecting the entire cluster.

Each project has access to the complete set of features and APIs of the distributed search engine application, ensuring that no functionality is compromised despite the shared infrastructure. Users of each project are unaware of the co-located projects within the cluster, providing a seamless and consistent user experience.

The search and analytics platform with multi-project clusters simplifies management, as managing a single cluster with multiple projects is generally simpler than managing multiple independent clusters. This reduces administrative overhead and simplifies monitoring and maintenance tasks. Configuration and updates can be managed centrally, ensuring consistency and reducing the risk of configuration drift across multiple clusters.

The ability to dynamically allocate resources and manage namespaces allows the platform to scale efficiently as the number of projects grows. The platform can adapt to different project requirements and workloads, providing a flexible solution that can accommodate a wide range of use cases.

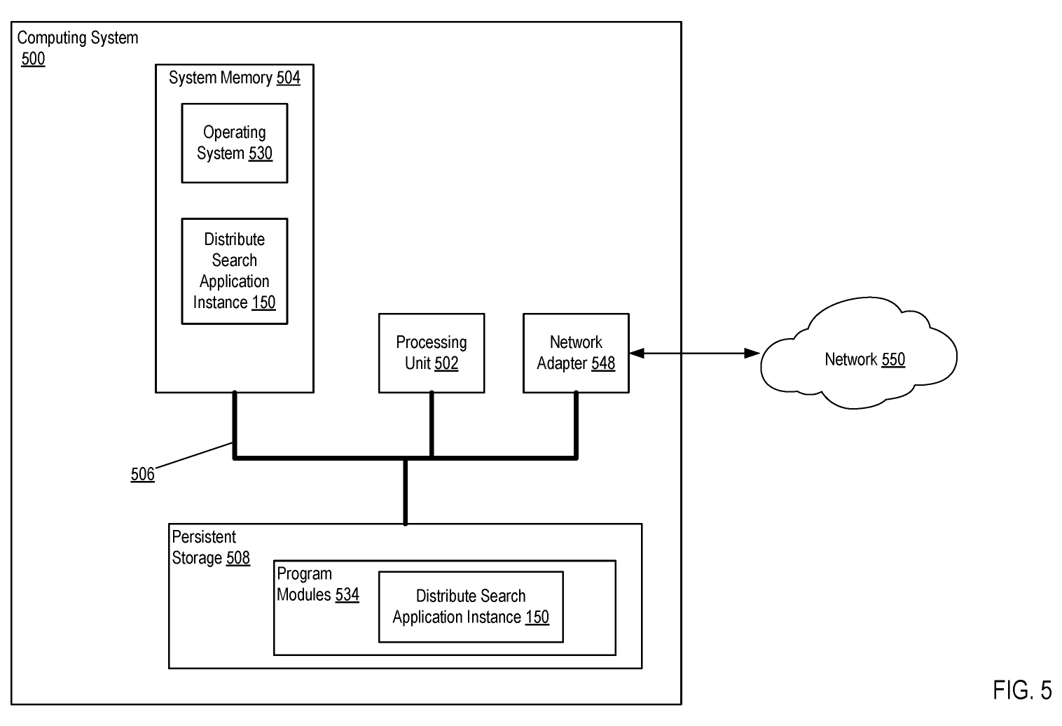

For further explanation, FIG. 5 depicts an example computer 500 in which embodiments may be implemented. Any element of cluster 102 may be implemented using computer 500, including one or more features of computer 500 and/or alternative features. Computer 500 may be a general-purpose computing device in the form of a conventional personal computer, a mobile computer, or a workstation, for example, or computer 500 may be a special purpose computing device. The description of computer 500 provided herein is provided for the purposes of illustration and is not intended to be limiting. Embodiments may be implemented in further types of computer systems, as would be known to persons skilled in the relevant art(s).

As shown in FIG. 5, computer 500 includes a processing unit 502, a system memory 504, and a bus 506 that couples various system components including system memory 504 to processing unit 502. Bus 506 represents one or more of any of several types of bus structures, including a memory bus or memory controller, a peripheral bus, an accelerated graphics port, and a processor or local bus using any of a variety of bus architectures. System memory 504 includes random access memory (RAM).

Computer 500 also has persistent storage 508 in the form of, for example, a magnetic disk or a solid-state drive connected to bus 506 by bus interface. The persistent storage 508 and their associated computer-readable storage media provide nonvolatile storage of computer-readable instructions, data structures, program modules and other data for the computer. Although a magnetic disk and solid-state driver are described, other types of computer-readable storage media can be used to store data.

An operating system 530 and number of program modules 534 may be stored in persistent storage 508. Application program modules 534 may include, for example, computer program logic for implementing an instance of a distributed search engine application 150.

Computer 500 is connected to a network 550 (e.g., the Internet) through a network interface or adapter 548, or other means for establishing communications over the network. For example, network 550 may be used for communication with client systems 106 or object store 104.

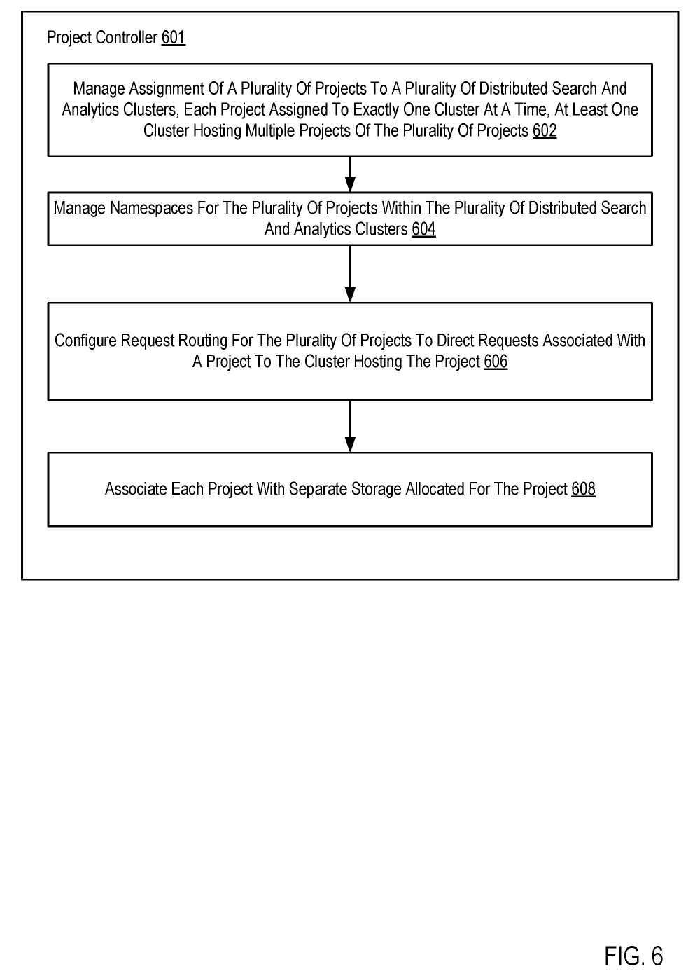

For further explanation, FIG. 6 sets forth a method of orchestrating projects in a distributed search and analytics platform. The method of FIG. 6 illustrates how a project controller 601 coordinates assignment of projects to clusters, management of namespaces, configuration of request routing, and association of projects with separate storage. In some embodiments, the project controller 601 may be implemented as, or may correspond to, an instance of the project assignment controller 162 of FIG. 1. The method provides an orchestration workflow for managing multiple projects within one or more distributed search and analytics clusters while maintaining isolation and efficient resource utilization.

The method of FIG. 6 includes managing 602, by a project controller 601 executing on one or more processors, assignment of a plurality of projects to a plurality of distributed search and analytics clusters. In the example of FIG. 6, each project is assigned to exactly one cluster at a time and at least one cluster hosting multiple projects of the plurality of projects. Managing 602, by a project controller 601 executing on one or more processors, assignment of a plurality of projects to a plurality of distributed search and analytics clusters may be carried out by maintaining project ownership information that identifies, for each project, a cluster to which the project is assigned. The project controller 601 may evaluate availability or capacity information associated with the clusters and select a cluster to host a project, ensuring that each project is assigned to exactly one cluster at a time while allowing at least one cluster to host multiple projects. In response to creation, removal, or migration of a project, the project controller 601 may update the project ownership information and communicate assignment changes to one or more clusters. In this manner, the project controller 601 orchestrates placement of projects on clusters while maintaining isolation and enabling efficient utilization of cluster resources.

The method of FIG. 6 also includes managing 604, by the project controller 601, namespaces for the plurality of projects within the plurality of distributed search and analytics clusters. In the example of FIG. 6, managing 604, by the project controller 601, namespaces for the plurality of projects within the plurality of distributed search and analytics clusters may be carried out by establishing and maintaining, for each project assigned to a cluster, a corresponding namespace that isolates named resources of the project from other projects hosted by the cluster. The project controller 601 may instruct one or more nodes of a cluster to create, update, or remove namespaces in response to project creation, assignment, migration, or removal events. Named resources associated with a project, including indices, templates, ingestion pipelines, and security roles, may be accessed only within the namespace corresponding to the project. In this manner, multiple projects may coexist within a cluster without naming collisions or unintended access to resources associated with other projects.

In addition, the method of FIG. 6 includes configuring 606, by the project controller 601, request routing for the plurality of projects to direct requests associated with a project to the cluster hosting the project. In the example of FIG. 6, configuring 606, by the project controller 601, request routing for the plurality of projects to direct requests associated with a project to the cluster hosting the project may be carried out by maintaining routing information that maps projects to clusters. The project controller 601 may provide the routing information to a proxy server or other trusted component that associates incoming requests with project identifiers prior to forwarding the requests to a cluster. Upon receiving a request, a node of the cluster may determine, based on the project identifier, the project to which the request corresponds and route the request to resources associated with the project. In this way, requests are transparently directed to the appropriate cluster without requiring client awareness of project placement.

The method of FIG. 6 also includes associating 608, by the project controller 601, each project with separate storage allocated for the project. In the example of FIG. 6, associating 608, by the project controller 601, each project with separate storage allocated for the project may be carried out by provisioning storage resources that are isolated on a per-project basis. The project controller 601 may maintain storage location and access information for each project and communicate the storage information to the cluster hosting the project. Data generated or accessed by a project may be stored exclusively in storage allocated for that project, thereby maintaining data independence and security between projects. Associating separate storage for each project enables independent data management while allowing multiple projects to share compute resources of a cluster.

The method of FIG. 6 enables a distributed search and analytics platform to coordinate operation of multiple independent projects within shared infrastructure while preserving project-level isolation and predictable behavior. By centralizing assignment, namespace management, request routing, and storage association under control of the project controller 601, the platform ensures that projects may be created, removed, migrated, and serviced without requiring changes to client behavior or application interfaces. The method supports concurrent operation of multiple projects on a cluster while preventing naming collisions, unintended data access, and resource contention. In this manner, the method provides a scalable orchestration mechanism that allows shared compute resources to be efficiently utilized while maintaining independence of project execution.

The method of FIG. 6 addresses technical challenges that arise in distributed search and analytics systems when supporting multiple workloads with differing performance and isolation requirements. Specifically, the method improves operation of the distributed search and analytics platform by introducing a controller-driven mechanism that dynamically manages project placement, request routing, and resource scoping at runtime based on system state. These operations are performed at the level of cluster coordination, namespace isolation, and request execution, and directly affect how the distributed search engine processes requests and accesses data. As a result, the method provides a concrete improvement to the functioning of distributed search and analytics platforms by enabling multi-project operation with controlled isolation, efficient resource utilization, and reduced reliance on static provisioning or manual configuration.

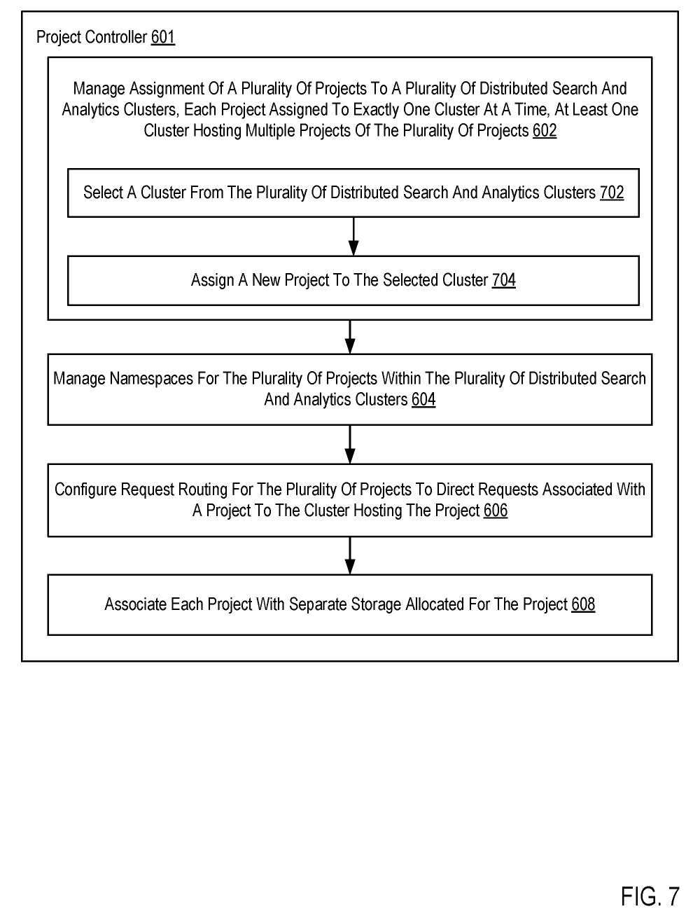

For further explanation, FIG. 7 sets forth a method of orchestrating projects in a distributed search and analytics platform. The method of FIG. 7 is similar to the method of FIG. 6 in that the method of FIG. 7 includes all of the steps of the method of FIG. 6. The method of FIG. 7 further illustrates additional aspects of managing assignment of projects to clusters, particularly in connection with creation of new projects.

In the method of FIG. 7, managing 602 assignment of a plurality of projects to a plurality of distributed search and analytics clusters includes selecting 702 a cluster from the plurality of distributed search and analytics clusters. Selecting 702 the cluster may be carried out by the project controller 601 based on availability, capacity, or other placement criteria associated with the clusters. The project controller 601 may evaluate cluster state information to identify a cluster capable of hosting the new project while maintaining desired performance and isolation characteristics.

In addition, managing 602 assignment of a plurality of projects to a plurality of distributed search and analytics clusters includes assigning 704 a new project to the selected cluster. Assigning 704 the new project may include updating project ownership information to associate the new project with the selected cluster and initiating establishment of a namespace and storage association for the new project. Once assigned, requests associated with the new project may be routed to the selected cluster in accordance with the request routing configuration. In this manner, new projects may be dynamically placed on clusters while ensuring that each project is assigned to exactly one cluster at a time.

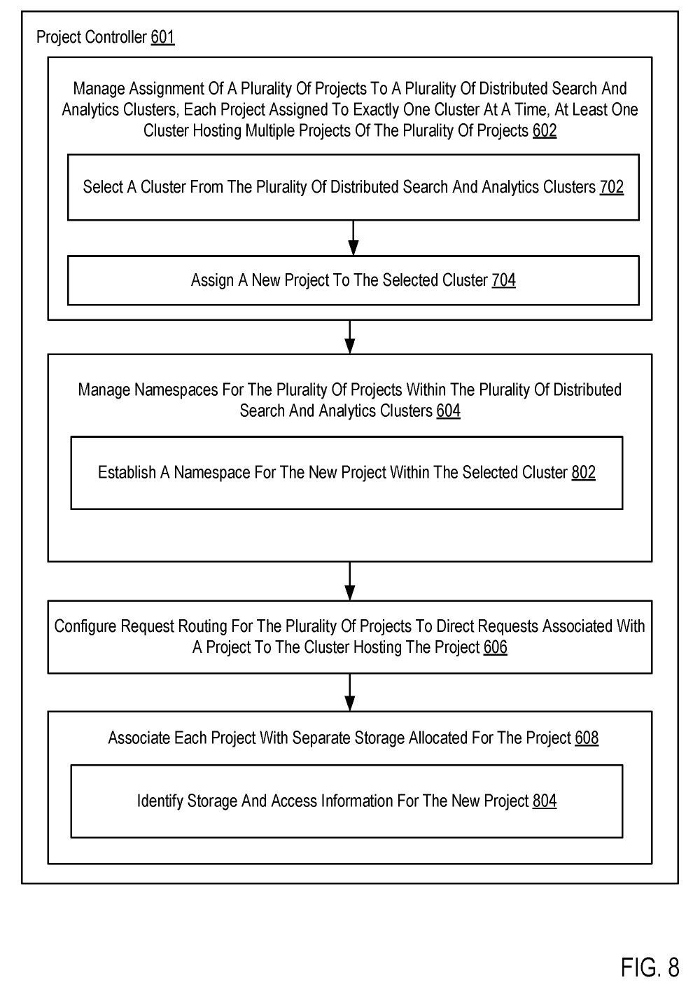

For further explanation, FIG. 8 sets forth a method of orchestrating projects in a distributed search and analytics platform. The method of FIG. 8 is similar to the method of FIG. 7 in that the method of FIG. 8 includes all of the steps of the method of FIG. 7. The method of FIG. 8 further illustrates additional aspects of namespace management and storage association performed during creation of a new project.

In the method of FIG. 8, managing 604 namespaces for the plurality of projects within the plurality of distributed search and analytics clusters includes establishing 802 a namespace for the new project within the selected cluster. Establishing 802 the namespace may be carried out by the project controller 601 by instructing one or more nodes of the selected cluster to create a namespace corresponding to the new project. The namespace may be configured to isolate named resources of the new project from named resources of other projects hosted by the cluster. In this manner, the new project may operate independently within the cluster without naming collisions or unintended access to resources of other projects.

In addition, in the method of FIG. 8, associating 608, by the project controller 601, each project with separate storage allocated for the project includes identifying 804 storage and access information for the new project. Identifying 804 the storage and access information may include selecting a storage location allocated exclusively for the new project and determining credentials or access parameters for accessing the storage. The project controller 601 may associate the storage and access information with the new project and communicate the information to the cluster hosting the project. Data generated or accessed by the new project may thereafter be stored in the separate storage allocated for the project, thereby maintaining data independence and security.

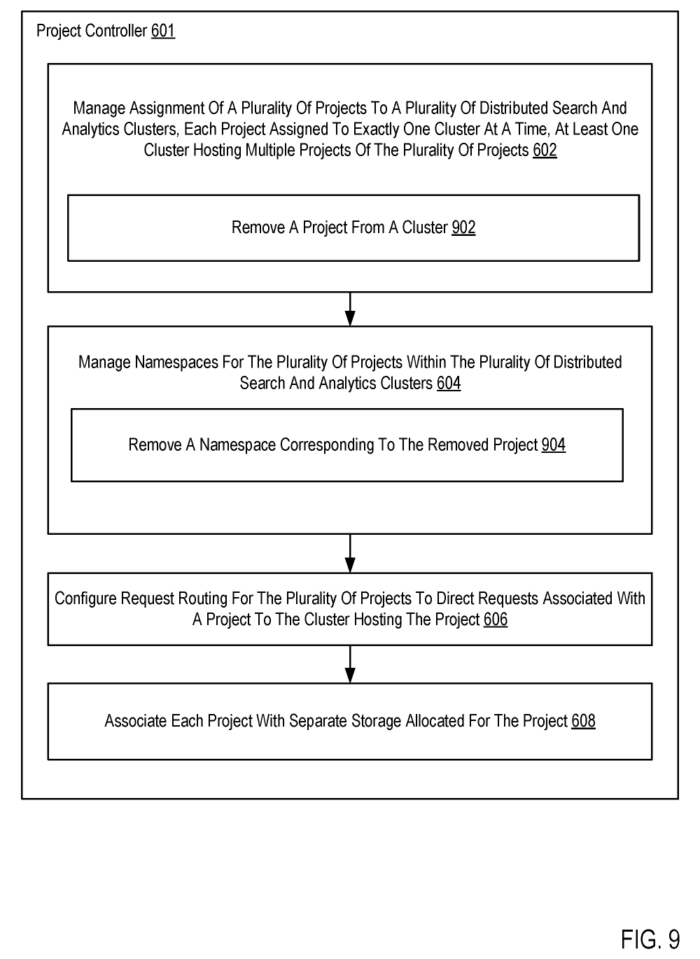

For further explanation, FIG. 9 sets forth a method of orchestrating projects in a distributed search and analytics platform. The method of FIG. 9 is similar to the method of FIG. 6 in that the method of FIG. 9 includes all of the steps of the method of FIG. 6. The method of FIG. 9 further illustrates aspects of project removal and corresponding cleanup operations performed by the project controller.

In the method of FIG. 9, managing 602 assignment of a plurality of projects to a plurality of distributed search and analytics clusters includes removing 902 a project from a cluster. Removing 902 the project may be carried out by the project controller 601 by disassociating the project from the cluster to which the project was previously assigned and updating project ownership information accordingly. Once removed, the project is no longer considered to be hosted by the cluster, and requests associated with the project may no longer be routed to the cluster. In this manner, projects may be dynamically removed from clusters during decommissioning, migration, or other lifecycle events.

In addition, in the method of FIG. 9, managing 604 namespaces for the plurality of projects within the plurality of distributed search and analytics clusters includes removing 904 a namespace corresponding to the removed project. Removing 904 the namespace may be carried out by instructing one or more nodes of the cluster to delete or deactivate the namespace associated with the project. Removal of the namespace prevents access to named resources previously associated with the project and frees resources for use by other projects hosted by the cluster. In this way, namespace removal ensures proper cleanup and isolation following removal of a project from a cluster.

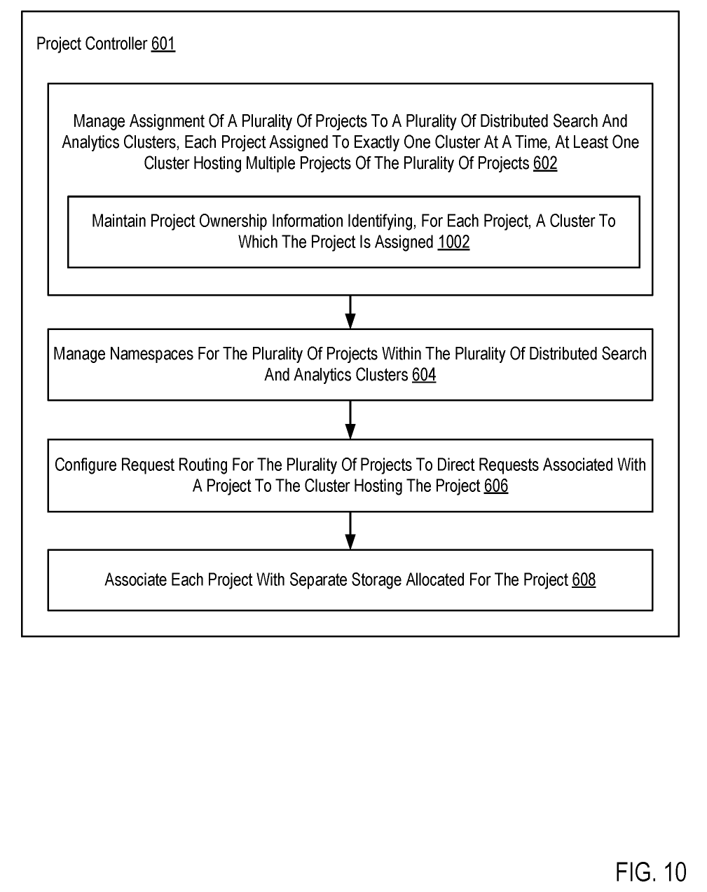

For further explanation, FIG. 10 sets forth a method of orchestrating projects in a distributed search and analytics platform. The method of FIG. 10 is similar to the method of FIG. 6 in that the method of FIG. 10 includes all of the steps of the method of FIG. 6. The method of FIG. 10 further illustrates maintenance of project ownership information used by the project controller to orchestrate project placement within the platform.

In the method of FIG. 10, managing 602 assignment of a plurality of projects to a plurality of distributed search and analytics clusters includes maintaining 1002 project ownership information identifying, for each project, a cluster to which the project is assigned. The project ownership information may be maintained by the project controller 601 in a data structure accessible to one or more clusters or platform components. The project ownership information may be updated in response to project creation, removal, migration, or reassignment events. In this manner, the project controller 601 maintains authoritative knowledge of project-to-cluster assignments to enable correct request routing, namespace management, and storage association.

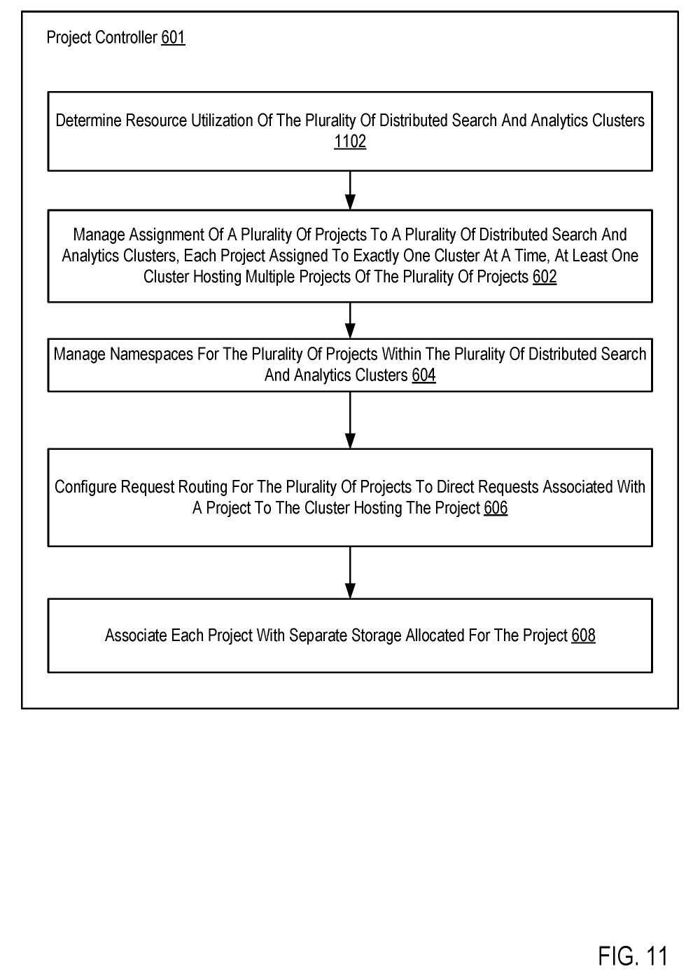

For further explanation, FIG. 11 sets forth a method of orchestrating projects in a distributed search and analytics platform. The method of FIG. 11 is similar to the method of FIG. 6 in that the method of FIG. 11 includes all of the steps of the method of FIG. 6. The method of FIG. 11 further illustrates monitoring of resource utilization by the project controller to support orchestration decisions.

The method of FIG. 11 also includes determining 1102, by the project controller 601, resource utilization of the plurality of distributed search and analytics clusters. Determining 1102 resource utilization may include obtaining metrics associated with compute usage, memory usage, storage utilization, query load, or indexing throughput of the clusters. The project controller 601 may collect the resource utilization information from one or more nodes of the clusters or from cluster state information maintained by the platform. In this manner, the project controller 601 may use resource utilization information to inform decisions related to project placement, migration, isolation, or scaling within the distributed search and analytics platform.

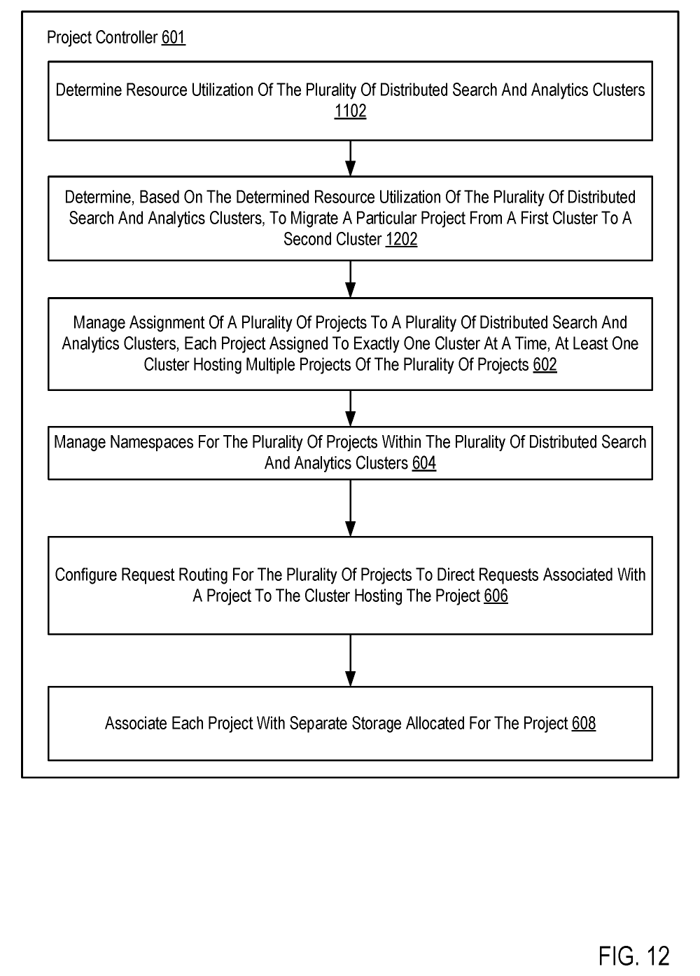

For further explanation, FIG. 12 sets forth a method of orchestrating projects in a distributed search and analytics platform. The method of FIG. 12 is similar to the method of FIG. 11 in that the method of FIG. 12 includes all of the steps of the method of FIG. 11. The method of FIG. 12 further illustrates decision-making by the project controller based on the determined resource utilization.

The method of FIG. 12 also includes determining 1202, based on the determined resource utilization of the plurality of distributed search and analytics clusters, by the project controller 601, to migrate a particular project from a first cluster to a second cluster. Determining 1202 to migrate the project may include identifying that resource utilization associated with the first cluster exceeds a threshold or that the second cluster has available capacity to host the project. The project controller 601 may select the second cluster to improve performance, balance load, or maintain isolation between projects. In response to the determination to migrate the project, the project controller 601 may initiate reassignment of the project to the second cluster in accordance with the methods described above.

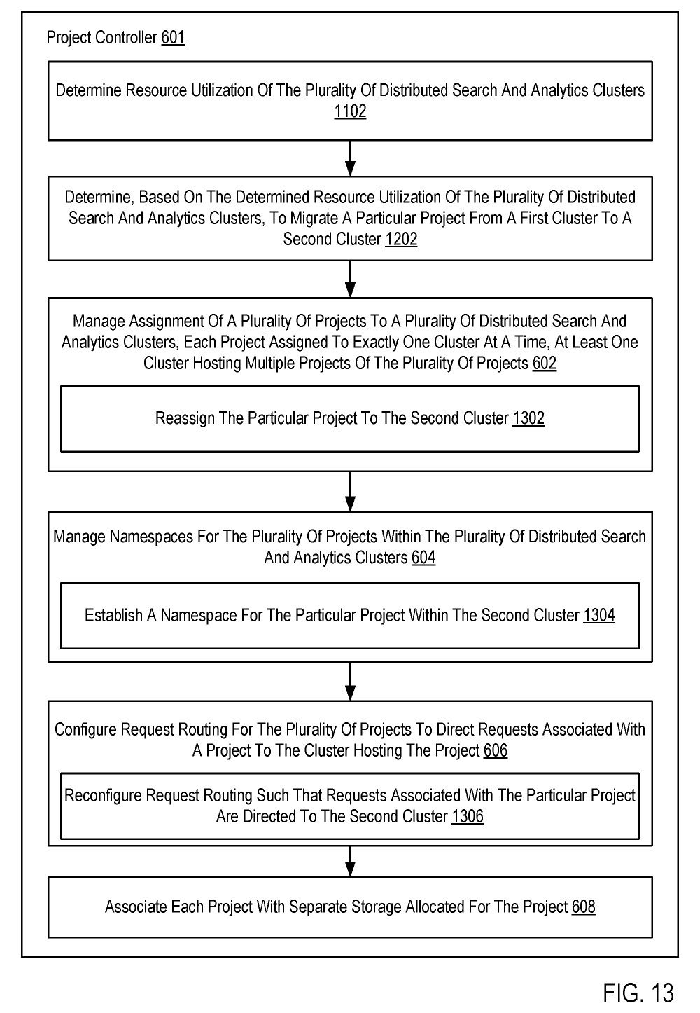

For further explanation, FIG. 13 sets forth a method of orchestrating projects in a distributed search and analytics platform. The method of FIG. 13 is similar to the method of FIG. 12 in that the method of FIG. 13 includes all of the steps of the method of FIG. 12. The method of FIG. 13 further illustrates execution of the migration of the particular project between clusters.

In the method of FIG. 13, managing 602 assignment of a plurality of projects to a plurality of distributed search and analytics clusters includes reassigning 1302 the particular project to the second cluster. Reassigning 1302 the particular project may be carried out by the project controller 601 by updating project ownership information to associate the particular project with the second cluster. Following reassignment, the particular project is considered to be hosted by the second cluster and no longer hosted by the first cluster. In this manner, project ownership is transitioned between clusters while maintaining the invariant that each project is assigned to exactly one cluster at a time.

In addition, in the method of FIG. 13, managing 604 namespaces for the projects within the clusters includes establishing 1304 a namespace for the particular project within the second cluster. Establishing 1304 the namespace may include instructing one or more nodes of the second cluster to create a namespace corresponding to the particular project. The namespace may be configured to isolate named resources of the particular project from named resources of other projects hosted by the second cluster. In this way, the particular project may operate independently within the second cluster following migration.

In the method of FIG. 13, configuring 606 request routing for the projects to direct requests associated with the projects to clusters hosting the projects includes reconfiguring 1306 request routing such that requests associated with the particular project are directed to the second cluster. Reconfiguring 1306 request routing may include updating routing information maintained by the project controller 601 or communicating updated routing information to a proxy server or other trusted component. After reconfiguration, requests associated with the particular project are routed to the second cluster for servicing. This ensures continuity of service for the particular project during and after migration.

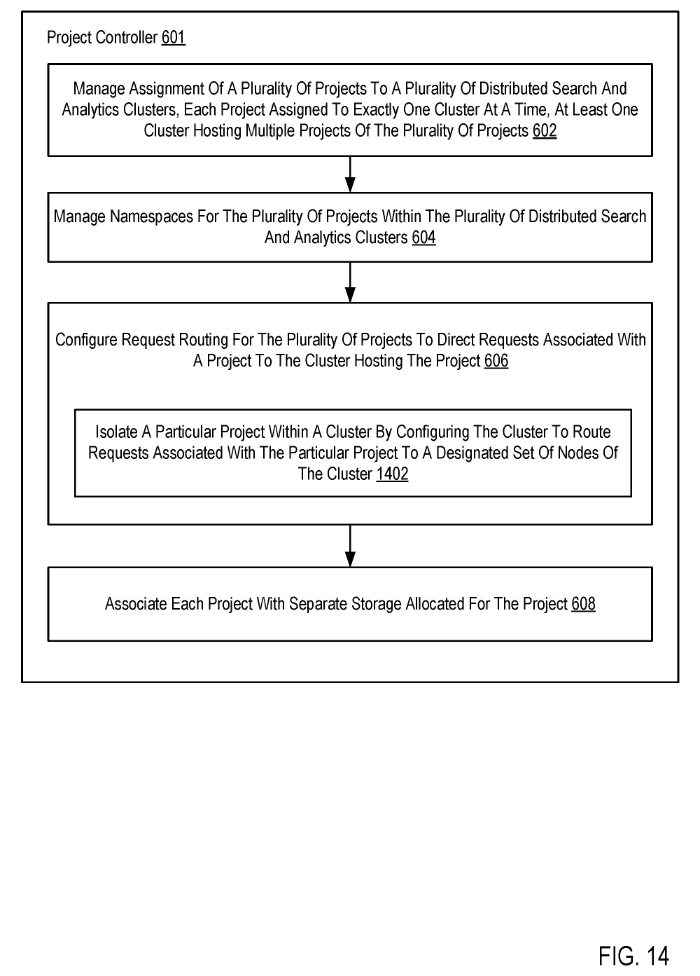

For further explanation, FIG. 14 sets forth a method of orchestrating projects in a distributed search and analytics platform. The method of FIG. 14 is similar to the method of FIG. 6 in that the method of FIG. 14 includes all of the steps of the method of FIG. 6. The method of FIG. 14 further illustrates isolation of a particular project within a cluster to mitigate resource contention.

In the method of FIG. 14, configuring 606 request routing for the projects to direct requests associated with the projects to clusters hosting the projects includes isolating 1402 a particular project within a cluster by configuring the cluster to route requests associated with the particular project to a designated set of nodes of the cluster. Isolating 1402 the particular project may be carried out by the project controller 601 by updating routing or scheduling information such that requests associated with the particular project are serviced only by the designated set of nodes. The designated set of nodes may provide separate pools of compute, memory, and storage resources for the particular project, thereby preventing the project from impacting performance of other projects hosted by the cluster. In this manner, resource-intensive projects may be isolated dynamically without requiring reconfiguration by clients associated with the projects.

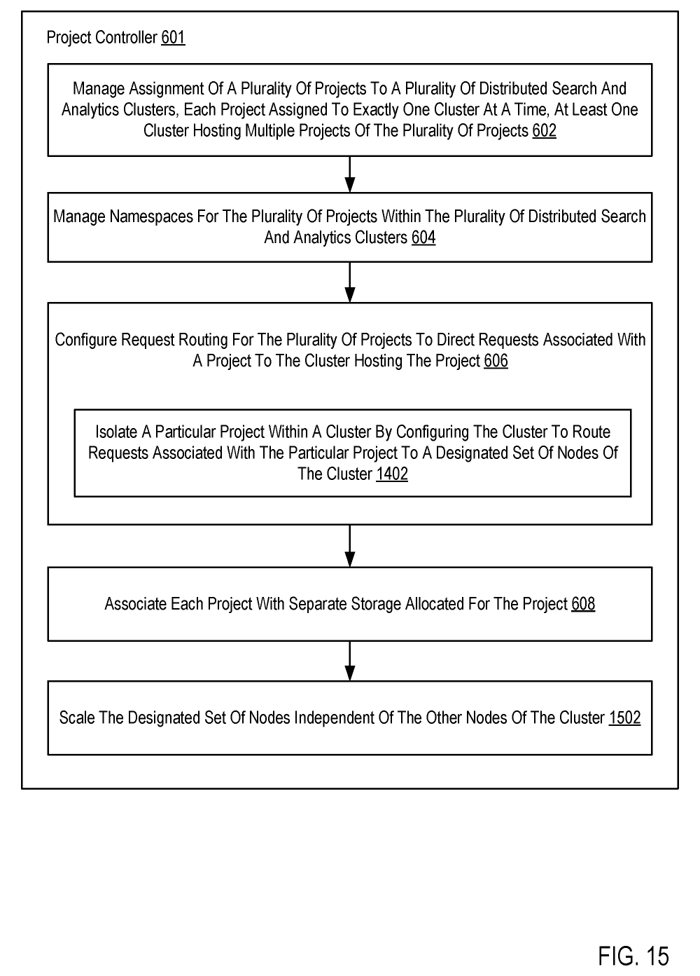

For further explanation, FIG. 15 sets forth a method of orchestrating projects in a distributed search and analytics platform. The method of FIG. 15 is similar to the method of FIG. 14 in that the method of FIG. 15 includes all of the steps of the method of FIG. 14. The method of FIG. 15 further illustrates independent scaling of the designated set of nodes associated with the isolated project.

The method of FIG. 15 includes scaling 1502 the designated set of nodes independent of the other nodes of the cluster. Scaling 1502 the designated set of nodes may be carried out by adding or removing nodes from the designated set based on workload demand associated with the particular project. The project controller 601 may initiate scaling operations without affecting nodes that service other projects hosted by the cluster. In this manner, resources allocated to the particular project may be adjusted dynamically while maintaining isolation and stable performance for other projects.

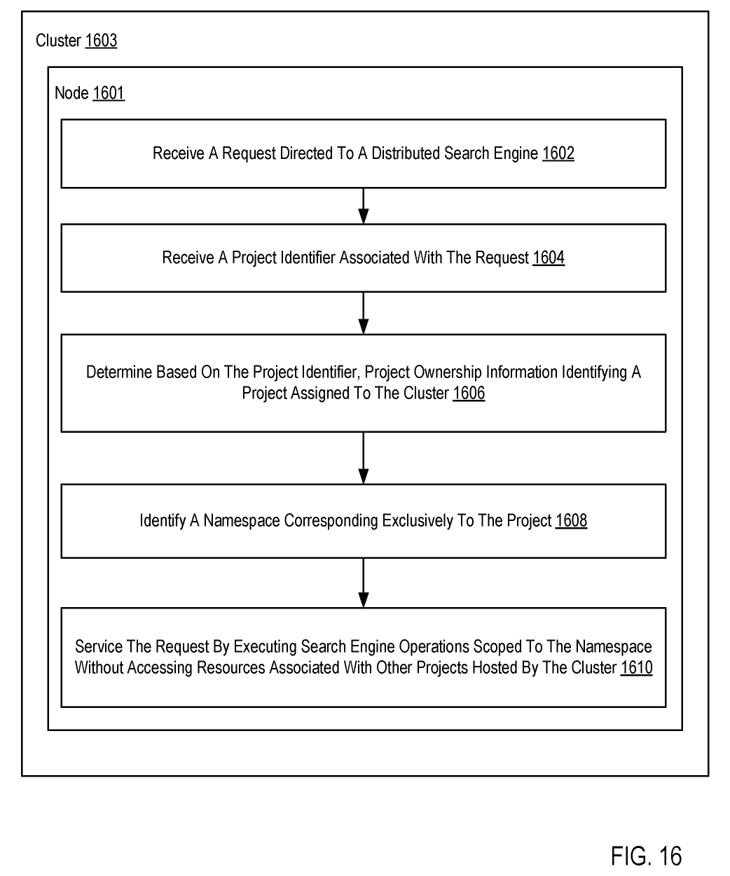

For further explanation, FIG. 16 sets forth a method of servicing requests in a distributed search and analytics platform hosting a plurality of projects. The method of FIG. 16 illustrates how requests directed to a distributed search engine are processed by a cluster while maintaining isolation between projects hosted by the cluster.

The method of FIG. 16 includes receiving 1602, by a node 1601 of a distributed search and analytics cluster 1603, a request directed to a distributed search engine. In some embodiments, the node 1601 may be implemented as one of the nodes 120 of FIG. 1. The request may originate from a client system and be forwarded to the cluster 1603 for processing. The node 1601 may execute a distributed search engine process capable of servicing requests for multiple projects hosted by the cluster.

The method of FIG. 16 further includes receiving 1604, by the node 1601, a project identifier associated with the request. In a particular embodiment, the project identifier is provided by a proxy server that authenticates the request prior to associating the project identifier with the request. In a particular embodiment, the project identifier is inserted into a header of the request. The project identifier enables the node 1601 to determine the project to which the request corresponds.

The method of FIG. 16 also includes determining 1606, based on the project identifier, by the node 1601, project ownership information identifying a project assigned to the cluster 1603. The project ownership information may indicate that the project associated with the request is hosted by the cluster 1603 and is authorized to be serviced by the node 1601. If the project ownership information does not indicate that the project is assigned to the cluster 1603, the request may be rejected or redirected.

In addition, the method of FIG. 16 includes identifying 1608, by the node 1601, a namespace corresponding exclusively to the project. The namespace may define a scope within which named resources of the project are accessible. By identifying the namespace corresponding to the project, the node 1601 ensures that subsequent operations are limited to resources associated with the project.

The method of FIG. 16 further includes servicing 1610, by the node 1601, the request by executing search engine operations scoped to the namespace without accessing resources associated with other projects hosted by the cluster. Executing search engine operations may include accessing indices, shards, templates, ingestion pipelines, or security roles associated with the project. In this manner, the node 1601 services requests for multiple projects hosted by the cluster while maintaining isolation and preventing access to resources of other projects.

The method of FIG. 16 enables a distributed search and analytics cluster to service requests for multiple projects within a single distributed search engine process while enforcing project-level isolation during request execution. By associating each request with a project identifier and resolving the identifier to project ownership information and a corresponding namespace, the node 1601 ensures that search engine operations are executed only within the scope of the identified project. This approach allows a cluster to host multiple projects concurrently without requiring separate search engine instances or separate clusters for each project. As a result, the method supports efficient use of shared compute resources while maintaining separation of data and named resources across projects.

The method of FIG. 16 improves operation of the distributed search and analytics platform by introducing a request-level mechanism that dynamically scopes execution of search engine operations based on project ownership and namespace resolution. Rather than relying on static configuration or client-defined naming conventions, the node 1601 determines, at request time, how the distributed search engine should access indices, shards, and other internal resources. This request-scoped execution directly affects how the distributed search engine processes queries and manages access to internal data structures. In this manner, the method provides a concrete technical improvement to request processing in distributed search systems by enabling multi-project execution with enforced isolation and controlled access at the search engine level.

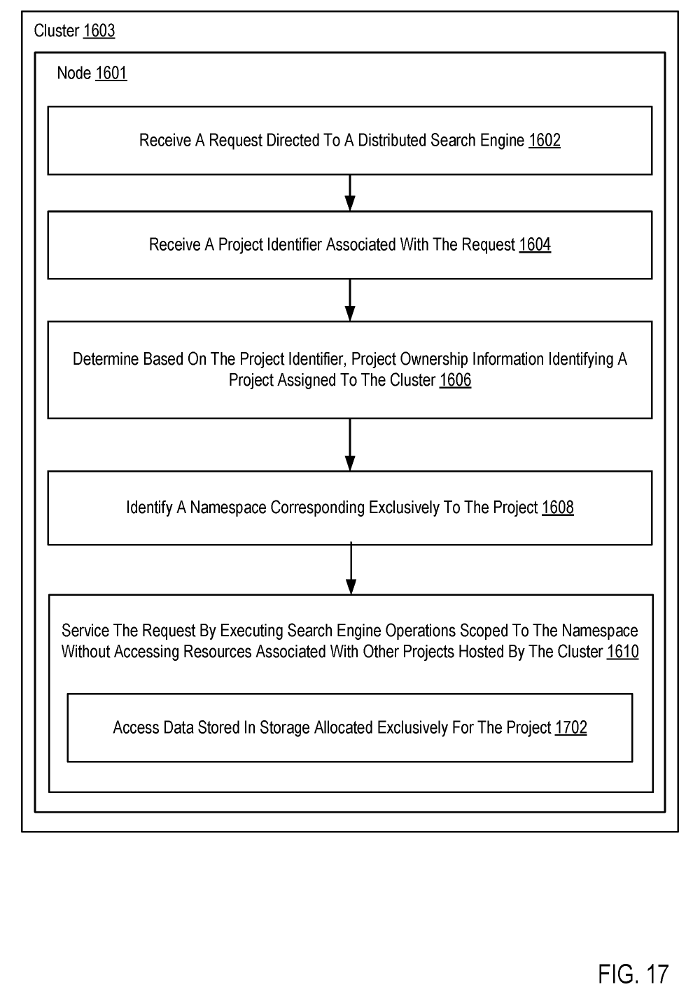

For further explanation, FIG. 17 sets forth a method of servicing requests in a distributed search and analytics platform hosting a plurality of projects. The method of FIG. 17 is similar to the method of FIG. 16 in that the method of FIG. 17 includes all of the steps of the method of FIG. 16. The method of FIG. 17 further illustrates accessing project-specific storage during request servicing.

In the method of FIG. 17, servicing 1610 the request includes accessing 1702 data stored in storage allocated exclusively for the project. Accessing 1702 the data may include reading or writing data associated with the project from the storage allocated for the project. In a particular embodiment, the data includes indices, shards, templates, ingestion pipelines, or security roles associated with the project. By accessing data stored exclusively for the project, the node ensures data isolation between projects hosted by the cluster.

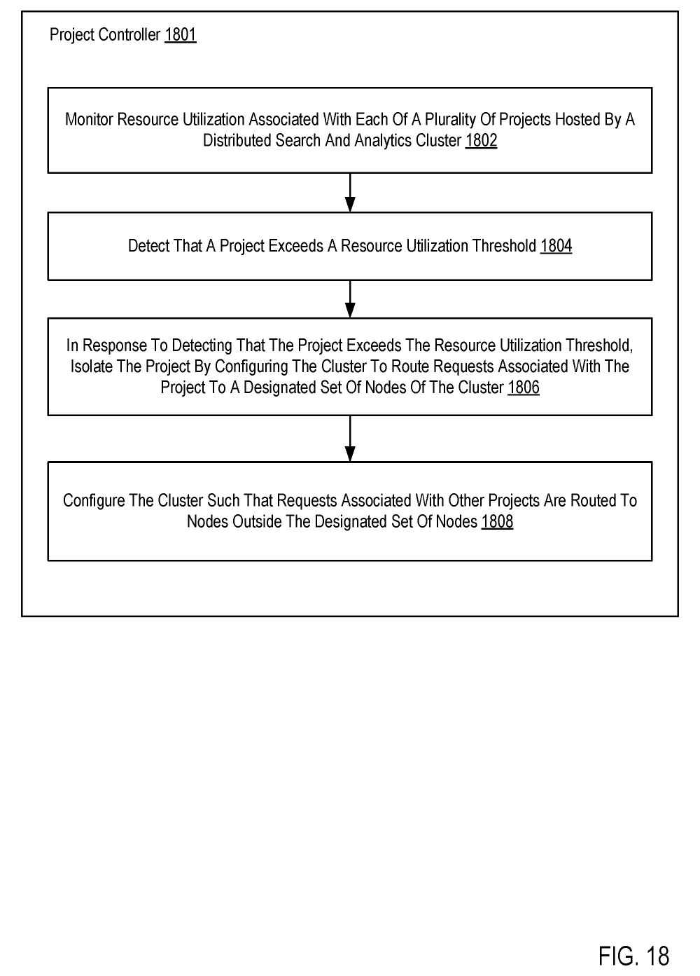

For further explanation, FIG. 18 sets forth a method of handling a resource-intensive project in a distributed search and analytics platform. The method of FIG. 18 illustrates how a project controller 1801 may detect and mitigate resource contention caused by a project hosted by a distributed search and analytics cluster. In some embodiments, the project controller 1801 may be implemented as, or may correspond to, the project assignment controller 162 of FIG. 1.

The method of FIG. 18 includes monitoring 1802, by the project controller 1801 executing on one or more processors, resource utilization associated with each of a plurality of projects hosted by a distributed search and analytics cluster. Monitoring 1802 resource utilization may include collecting metrics associated with compute usage, memory usage, query latency, indexing rate, or storage consumption for each project. The project controller 1801 may obtain the resource utilization information from one or more nodes of the cluster or from cluster state information maintained by the platform.

The method of FIG. 18 further includes detecting 1804, by the project controller 1801, that a project exceeds a resource utilization threshold. In a particular embodiment, the resource utilization threshold is based on at least one of compute usage, memory pressure, query latency, indexing rate, or storage consumption. Detection of the threshold condition may indicate that the project is resource-intensive and may adversely impact performance of other projects hosted by the cluster.

In response to detecting that the project exceeds the resource utilization threshold, the method of FIG. 18 includes isolating 1806, by the project controller 1801, the project by configuring the cluster to route requests associated with the project to a designated set of nodes of the cluster. Isolating 1806 the project may include updating routing or scheduling information such that requests associated with the project are serviced only by the designated set of nodes. The designated set of nodes may provide separate pools of compute, memory, and storage resources for the project.

The method of FIG. 18 further includes configuring 1808, by the project controller 1801, the cluster such that requests associated with other projects are routed to nodes outside the designated set of nodes. By routing requests for other projects away from the designated set of nodes, the project controller 1801 prevents the resource-intensive project from impacting performance of the other projects. In this manner, resource contention is mitigated while allowing the resource-intensive project to continue operating within the cluster.

The method of FIG. 18 enables a distributed search and analytics platform to manage heterogeneous workloads by dynamically identifying and isolating projects that exhibit elevated resource consumption. By monitoring resource utilization at the project level and selectively routing requests to a designated set of nodes, the project controller 1801 limits the impact of resource-intensive behavior on other projects hosted by the cluster. This approach allows multiple projects with differing workload characteristics to coexist within a single cluster while maintaining predictable performance. In this manner, the method supports efficient use of shared infrastructure without requiring preemptive over-provisioning or static isolation of resources.

The method of FIG. 18 improves operation of the distributed search and analytics platform by introducing a controller-driven mechanism that dynamically alters request routing and resource allocation based on observed system conditions. The isolation of a project is performed at the level of cluster routing and node assignment, directly affecting how the distributed search engine executes requests and allocates compute, memory, and storage resources. These operations are carried out in response to measured resource utilization rather than predefined policies or client input. As a result, the method provides a concrete technical improvement to distributed search systems by enabling adaptive mitigation of resource contention during runtime while preserving multi-project operation.

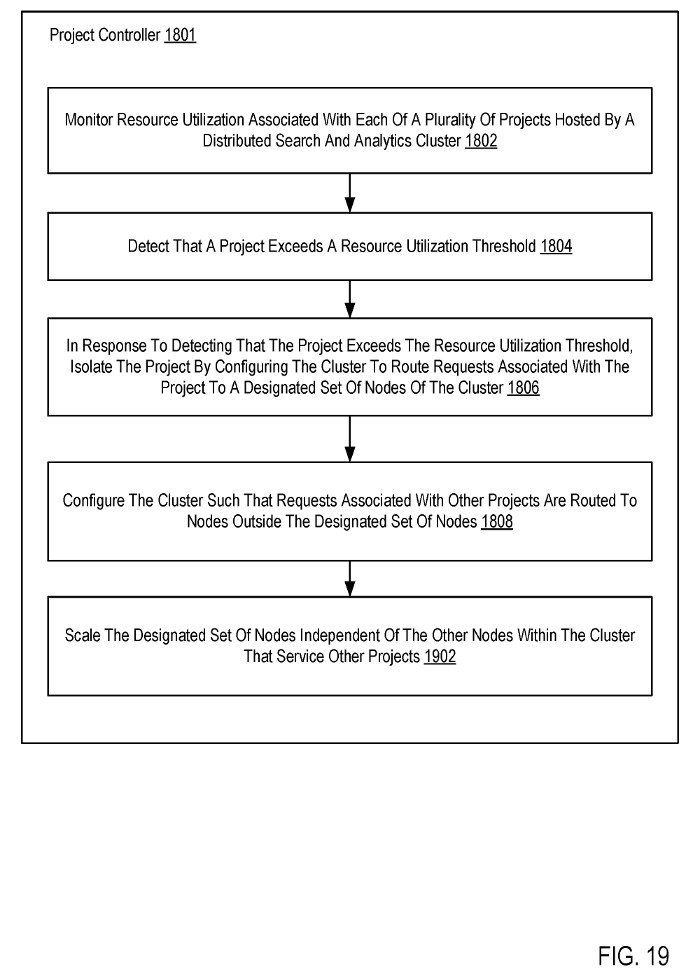

For further explanation, FIG. 19 sets forth a method of handling a resource-intensive project in a distributed search and analytics platform. The method of FIG. 19 is similar to the method of FIG. 18 in that the method of FIG. 19 includes all of the steps of the method of FIG. 18. The method of FIG. 19 further illustrates independent scaling of resources allocated to the isolated project.

The method of FIG. 19 includes scaling 1902 the designated set of nodes independent of the other nodes within the cluster that service other projects. Scaling 1902 the designated set of nodes may include adding nodes to or removing nodes from the designated set based on workload demand associated with the project. The project controller may initiate scaling of the designated set of nodes without affecting nodes that continue to service other projects hosted by the cluster. In this manner, resources allocated to the resource-intensive project may be adjusted dynamically while maintaining isolation and stable performance for the other projects.

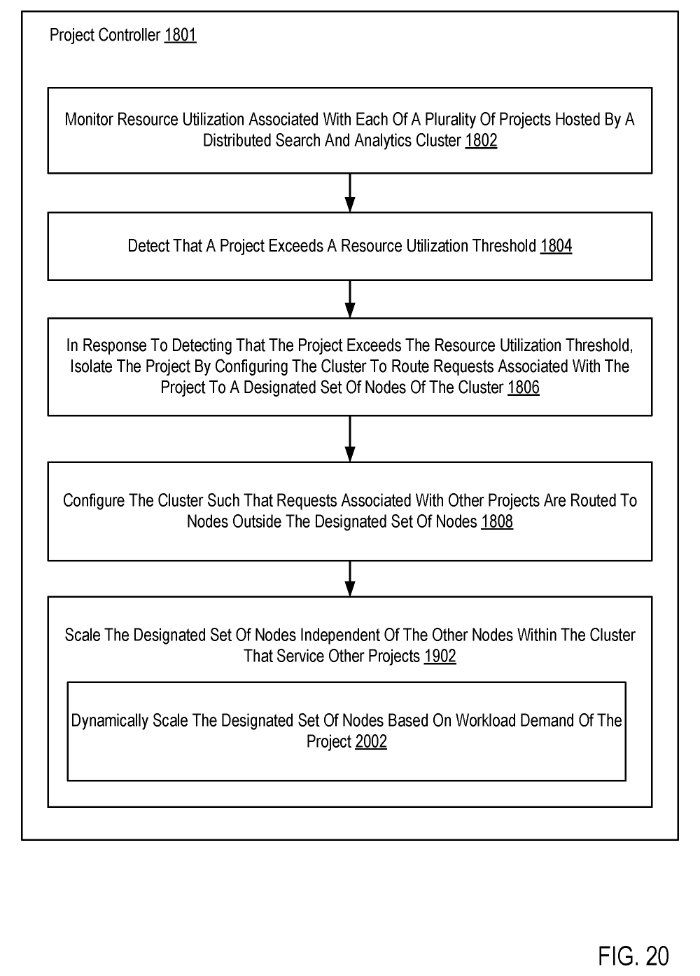

For further explanation, FIG. 20 sets forth a method of handling a resource-intensive project in a distributed search and analytics platform. The method of FIG. 20 is similar to the method of FIG. 19 in that the method of FIG. 20 includes all of the steps of the method of FIG. 20. The method of FIG. 20 further illustrates dynamic scaling of the designated set of nodes based on project workload.

In the method of FIG. 20, scaling 1902 the designated set of nodes independent of the other nodes within the cluster includes dynamically scaling 2002 the designated set of nodes based on workload demand of the project. Dynamically scaling 2002 the designated set of nodes may include increasing or decreasing the number of nodes in the designated set in response to changes in request volume, query complexity, indexing rate, or other workload characteristics associated with the project. The project controller may monitor workload demand and initiate scaling actions automatically without affecting nodes that service other projects hosted by the cluster. In this manner, resources allocated to the resource-intensive project are adjusted dynamically while preserving isolation and performance stability for other projects.

Exemplary embodiments of the present invention are described largely in the context of a fully functional computer system for orchestrating a multi-tenant search and analytics engine and datastore. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

In various embodiments, the methods described herein may be implemented by one or more systems comprising hardware, software, or a combination thereof. For example, a project controller, node, proxy server, or other component described herein may include one or more processors and one or more memory devices storing computer-readable instructions that, when executed by the one or more processors, cause the component to perform the operations described with reference to the methods of FIGS. 6–21. In such embodiments, the components may be configured to manage project assignment, namespace management, request routing, storage association, request servicing, resource monitoring, project isolation, and scaling operations as described herein. In some embodiments, the computer readable program instructions correspond to instructions for implementing the methods described with reference to FIGS. 6–21.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non- exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the "C" programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Hardware logic, including programmable logic for use with a programmable logic device (PLD) implementing all or part of the functionality previously described herein, may be designed using traditional manual methods or may be designed, captured, simulated, or documented electronically using various tools, such as Computer Aided Design (CAD) programs, a hardware description language (e.g., VHDL or Verilog), or a PLD programming language. Hardware logic may also be generated by a non-transitory computer readable medium storing instructions that, when executed by a processor, manage parameters of a semiconductor component, a cell, a library of components, or a library of cells in electronic design automation (EDA) software to generate a manufacturable design for an integrated circuit. In implementation, the various components described herein might be implemented as discrete components or the functions and features described can be shared in part or in total among one or more components. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of orchestrating projects in a distributed search and analytics platform, the method comprising:
managing, by a project controller executing on one or more processors, assignment of a plurality of projects to a plurality of distributed search and analytics clusters, each project assigned to exactly one cluster at a time, at least one cluster hosting multiple projects of the plurality of projects;
managing, by the project controller, namespaces for the plurality of projects within the plurality of distributed search and analytics clusters;
configuring, by the project controller, request routing for the plurality of projects to direct requests associated with a project to the cluster hosting the project; and
associating, by the project controller, each project with separate storage allocated for the project.

2. The method of claim 1 wherein managing assignment of a plurality of projects to a plurality of distributed search and analytics clusters includes:
selecting a cluster from the plurality of distributed search and analytics clusters; and
assigning a new project to the selected cluster.

3. The method of claim 2, wherein managing namespaces for the plurality of projects within the plurality of distributed search and analytics clusters includes establishing a namespace for the new project within the selected cluster;
wherein associating, by the project controller, each project with separate storage allocated for the project includes identifying storage and access information for the new project.

4. The method of claim 1, wherein managing assignment of a plurality of projects to a plurality of distributed search and analytics clusters includes removing a project from a cluster; and wherein managing namespaces for the plurality of projects within the plurality of distributed search and analytics clusters includes removing a namespace corresponding to the removed project.

5. The method of claim 1, wherein managing assignment of a plurality of projects to a plurality of distributed search and analytics clusters includes maintaining project ownership information identifying, for each project, a cluster to which the project is assigned.

6. The method of claim 1 further comprising determining, by the project controller, resource utilization of the plurality of distributed search and analytics clusters.

7. The method of claim 6 further comprising determining, based on the determined resource utilization of the plurality of distributed search and analytics clusters, by the project controller, to migrate a particular project from a first cluster to a second cluster.

8. The method of claim 7, wherein managing assignment of a plurality of projects to a plurality of distributed search and analytics clusters includes reassigning the particular project to the second cluster;
wherein managing namespaces for the projects within the clusters includes establishing a namespace for the particular project within the second cluster; and
wherein configuring request routing for the projects to direct requests associated with the projects to clusters hosting the projects includes reconfiguring request routing such that requests associated with the particular project are directed to the second cluster

9. The method of claim 1, wherein configuring request routing for the projects to direct requests associated with the projects to clusters hosting the projects includes isolating a particular project within a cluster by configuring the cluster to route requests associated with the particular project to a designated set of nodes of the cluster.

10. The method of claim 9, further comprising scaling the designated set of nodes independent of the other nodes of the cluster.

11. A method of servicing requests in a distributed search and analytics platform hosting a plurality of projects, the method comprising:
receiving, by a node of a distributed search and analytics cluster, a request directed to a distributed search engine;
receiving, by the node, a project identifier associated with the request;
determining based on the project identifier, by the node, project ownership information identifying a project assigned to the cluster;
identifying, by the node, a namespace corresponding exclusively to the project; and
servicing, by the node, the request by executing search engine operations scoped to the namespace without accessing resources associated with other projects hosted by the cluster.

12. The method of claim 11, wherein the project identifier is inserted into a header of the request.

13. The method of claim 11, wherein the project identifier is provided by a proxy server that authenticates the request prior to associating the project identifier with the request.

14. The method of claim 11, wherein servicing the request by executing the search engine operations scoped to the namespace includes accessing data stored in storage allocated exclusively for the project.

15. The method of claim 14, wherein the data includes indices, shards, templates, ingestion pipelines, or security roles associated with the project.

16. A method of handling a resource-intensive project in a distributed search and analytics platform, the method comprising:
monitoring, by a project controller executing on one or more processors, resource utilization associated with each of a plurality of projects hosted by a distributed search and analytics cluster;
detecting, by the project controller, that a project exceeds a resource utilization threshold;
in response to detecting that the project exceeds the resource utilization threshold, isolating, by the project controller, the project by configuring the cluster to route requests associated with the project to a designated set of nodes of the cluster; and
configuring, by the project controller, the cluster such that requests associated with other projects are routed to nodes outside the designated set of nodes.

17. The method of claim 16, wherein the resource utilization threshold is based on at least one of compute usage, memory pressure, query latency, indexing rate, or storage consumption.

18. The method of claim 16, wherein isolating the project provides separate pools of compute, memory, and storage resources for the project.

19. The method of claim 16, further comprising scaling, by the project controller, the designated set of nodes independent of the other nodes within the cluster that service other projects.

20. The method of claim 19, wherein scaling the designated set of nodes independent of the other nodes within the cluster includes dynamically scaling the designated set of nodes based on workload demand of the project.

21. The method of claim 16 where a highly utilized project will have its resource usage capped rather than isolated to protect other projects from being affected.
